(19) United States
(12) Patent Application Publication
(10) Pub. No.: US 2025/0356830 A1
(43) Pub. Date: Nov. 20, 2025

(54) ACOUSTIC PANELS AND WALL COVERING SYSTEMS

(71) Applicant: Turf Design, Inc., Gilberts, IL (US)

(72) Inventors: Robert Krejci, Chicago, IL (US); Jacob F. Mullins, Chicago, IL (US); Matthew Busscher, Chicago, IL (US); Cody TUCKER, Chicago, IL (US)

(21) Appl. No.: 19/173,462

(22) Filed: Apr. 8, 2025

Related U.S. Application Data
(60) Provisional application No. 63/632,246, filed on Apr. 10, 2024.

(51) Int. Cl. G10K 11/162; D06P 3/52

(52) U.S. Cl. CPC G10K 11/162; D06P 3/52

(57) ABSTRACT

An acoustic panel is disclosed comprising a first enclosed chamber, a second enclosed chamber, a front panel, and an unenclosed chamber defined between the first enclosed chamber, the second enclosed chamber, and the front panel. The acoustic panel can be folded into shape from a single piece of material. The acoustic panel can comprise a base color and ink printed on less than all of the exposed surfaces of the acoustic panel comprising the base color. The acoustic panel can comprise a design on the front panel and, in addition, side panels comprising designs that are an extension of the front design.

### CROSS-REFERENCE TO RELATED APPLICATION

This application claims priority to U.S. Provisional Patent Application No. 63/632,246, filed Apr. 10, 2024, entitled ACOUSTIC PANELS AND WALL COVERING SYSTEMS, which is hereby incorporated by reference in its entirety.

### FIELD OF DISCLOSURE

The present disclosure relates to acoustic building panels and surface covering systems.

### BACKGROUND

Building materials often perform poorly acoustically and are often unaesthetic. Accordingly, improved acoustic building panels and surface covering systems are desired to improve the acoustics and aesthetics within a room and/or space, for example.

### BRIEF SUMMARY

In one aspect, an acoustic panel comprises a first enclosed chamber, a second enclosed chamber, a front panel, and an unenclosed chamber defined between the first enclosed chamber, the second enclosed chamber, and the front panel. In various embodiments, the acoustic panel can be folded into shape from a single piece of material. The acoustic panel can comprise a front design on the front panel and, in addition, side panels comprising side designs that are an extension of the front design. Similarly, the acoustic panel can comprise end panels comprising end designs that are an extension of the front design and/or the side designs. The acoustic panel can comprise a base color and ink printed on less than all of the exposed surfaces of the acoustic panel comprising the base color to create the front design, the side designs, and/or the end designs. In various embodiments, the acoustic panel is a first acoustic panel that is part of an acoustic panel system including two or more additional acoustic panels. The additional acoustic panels can comprise front designs that are an extension of the front design of the first acoustic panel.

### BRIEF DESCRIPTION OF THE DRAWINGS

FIG. 1 is a perspective view of a panel assembly system including acoustic wall panels;

FIG. 2 is an elevational view of a panel assembly system including acoustic wall panels;

FIG. 3 is a detail perspective view of a corner of an acoustic wall panel illustrated in FIG. 2;

FIG. 4 is a perspective view of a wall mounting system of the panel assembly system of FIG. 1;

FIG. 5 is a detail view of the wall mounting system of FIG. 4;

FIG. 6 is a plan view of an acoustic wall panel of FIG. 1 mounted to a wall using the wall mounting system of FIG. 4;

FIG. 7A is a perspective view of an acoustic wall panel of FIG. 1 in an unfolded configuration;

FIG. 7B is a perspective view of the acoustic wall panel of FIG. 7A in a partially folded configuration;

FIG. 7C is a perspective view of the acoustic wall panel of FIG. 7A in an almost completely folded configuration;

FIG. 8 is a cross-sectional view of the acoustic wall panel of FIG. 1 attached to a wall using the wall mounting system of FIG. 4;

FIG. 9 is an elevational view of a panel assembly system including a book matched set of acoustic wall panels;

FIG. 10 is an elevational view of a panel assembly system including a book matched set of acoustic wall panels;

FIG. 11 is an elevational view of a panel assembly system including book matched sets of acoustic wall panels;

FIG. 12 is an elevational view of a panel assembly system including book matched sets of acoustic wall panels;

FIG. 13 is a schematic illustrating a method of creating a book matched set of acoustic wall panels;

FIGS. 14A-14E comprise a set of views of an acoustic wall panel;

FIG. 15 is a schematic illustrating an acoustic wall panel and a wall mounting system;

FIG. 16 is a schematic illustrating a panel assembly system including acoustic wall panels;

FIGS. 17A-17D illustrate a method of folding the acoustic wall panel of FIG. 16 into a folded configuration;

FIGS. 18A-18E comprise a set of views of an acoustic wall panel;

FIG. 19 is a perspective view of a panel assembly system including the acoustic wall panel of FIG. 18A-18E and a wall mounting system;

FIG. 20A is a perspective view the acoustic wall panel of FIGS. 18A-18E in an unfolded configuration;

FIG. 20B is a perspective view of the acoustic wall panel of FIGS. 18A-18E in a partially folded configuration;

FIG. 20C is a perspective view of the acoustic wall panel of FIGS. 18A-18E in an almost completely folded configuration;

FIG. 21 is an elevational view of a panel assembly system including a book matched set of acoustic wall panels;

FIG. 22 is an elevational view of a panel assembly system including a book matched sets of acoustic wall panels;

FIG. 23 is an elevational view of a panel assembly system including a book matched set of acoustic wall panels;

FIG. 24 is an elevational view of the panel assembly system of FIG. 23;

FIG. 25 is a perspective view of an acoustic wall panel;

FIG. 26 is a perspective view of an acoustic ceiling panel;

FIG. 27 is a cross-sectional view of the acoustic ceiling panel of FIG. 26;

FIG. 28 is a perspective view of the acoustic ceiling panel of FIG. 26 being assembled to a ceiling frame;

FIG. 29 is a perspective view of the acoustic ceiling panel of FIG. 26 assembled to the ceiling frame of FIG. 28;

FIG. 30 is a perspective view of a panel assembly system including acoustic ceiling panels mounted to a ceiling frame;

FIG. 31 is a top view of an acoustic ceiling panel;

FIG. 32 is a side view of the acoustic ceiling panel of FIG. 31;

FIG. 33 is a bottom view of the acoustic ceiling panel of FIG. 31;

FIG. 34 is a cross-sectional view of the acoustic ceiling panel of FIG. 31 mounted to a ceiling frame;

FIG. 35 is an elevational view of the acoustic ceiling panel of FIG. 31 mounted to the ceiling frame of FIG. 34;

FIG. 36 is a detail view of an end trim piece of the ceiling frame of FIG. 34; and

FIG. 37 is a detail view of a torsion spring connector connecting the acoustic panel of FIG. 31 to the ceiling frame of FIG. 34.

The detailed description of the disclosure will be better understood when read in conjunction with the appended drawings. It should be understood, however, that the disclosure is not limited to the precise arrangements and instrumentalities of the examples shown in the drawings.

### DETAILED DESCRIPTION

For illustrative purposes, the principles of the present disclosure are described by referencing various examples thereof. Although certain examples of the disclosure are specifically described herein, one of ordinary skill in the art will readily recognize that the same principles are equally applicable to, and can be employed in other applications and methods. It is to be understood that the disclosure is not limited in its application to the details of any particular example shown. The terminology used herein is for the purpose of description and not to limit the disclosure, its application, or uses.

As used herein and in the appended claims, the singular forms “a”, “an”, and “the” include plural references unless the context dictates otherwise. The singular form of any class of the ingredients refers not only to one chemical species within that class, but also to a mixture of those chemical species. The terms “a” (or “an”), “one or more” and “at least one” may be used interchangeably herein. The terms “comprising”, “including”, “containing”, and “having” may be used interchangeably. The term “include” should be interpreted as “include, but are not limited to”. The term “including” should be interpreted as “including, but are not limited to”.

As used throughout, ranges are used as shorthand for describing each and every value that is within the range. Any value within the range can be selected as the terminus of the range. Thus, any range of values disclosed herein is merely exemplary and includes all values and sub-ranges there-between.

Unless defined otherwise, all technical and scientific terms used herein have the same meanings as commonly understood by one of ordinary skill in the art to which this disclosure belongs. All patents, patent applications, publications, and other references cited or referred to herein are incorporated by reference in their entireties for all purposes. In the event of a conflict in a definition in the present disclosure and that of a cited reference, the present disclosure is controlling.

In the description of examples disclosed herein, any reference to direction or orientation is merely intended for convenience of description and is not intended in any way to limit the scope of the present disclosure. Relative terms such as “lower,” “upper,” “horizontal,” “vertical,”, “above,” “below,” “up,” “down,” “top” and “bottom” as well as derivatives thereof (e.g., “horizontally,” “downwardly,” “upwardly,” etc.) should be construed to refer to the orientation as then described or as shown in the drawing (if applicable) under discussion. These relative terms are for convenience of description only and, unless specified otherwise, do not require that the apparatus be constructed or operated in a particular orientation.

As used herein, terms such as “attached,” “affixed,” “connected,” “coupled,” “interconnected,” and the like refer to a relationship wherein structures are secured or attached to one another either directly or indirectly through intervening structures, as well as both movable or rigid attachments or relationships, unless expressly described otherwise. Accordingly, the disclosure is not limited to such examples illustrating certain combinations of features that may exist alone or in combination with other features.

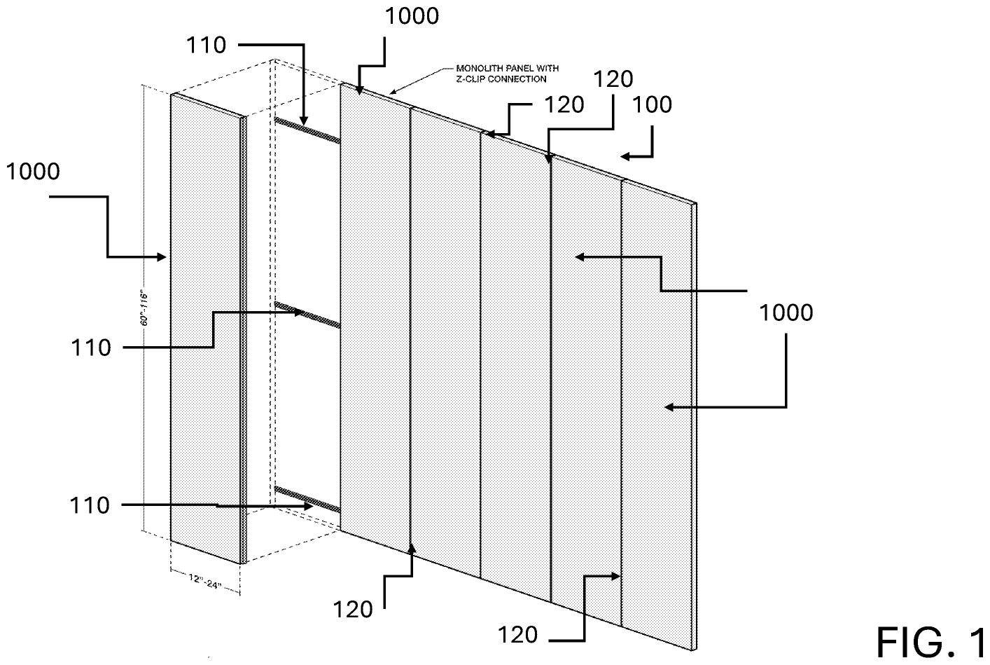

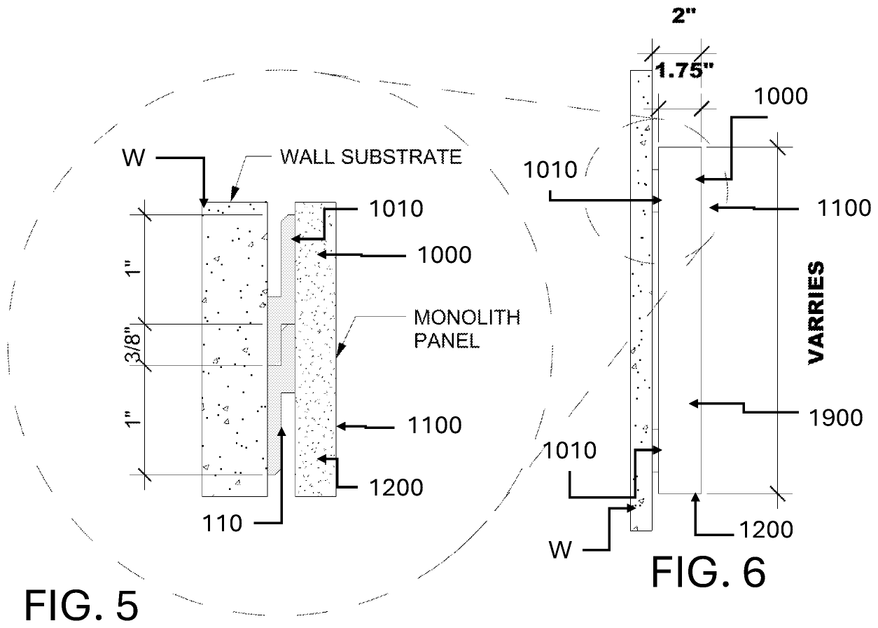

A wall panel assembly system 100 is illustrated in FIG. 1. The panel assembly system 100 comprises a plurality of acoustic wall panels 1000 and connector strips 110. Referring primarily to FIGS. 5 and 6, each connector strip 110 is mounted to a wall substrate W, such as drywall, cinder block, and/or plywood, for example. The connectors strips 110 are mounted to the wall substrate W by fasteners, for example, but could be mounted in the wall substrate W in any suitable manner, such as with one or more adhesives, for example. Each connector strip 110 comprises a Z-shaped cross-section, for example, but could comprise any suitable configuration. Each acoustic wall panel 1000 comprises one or more connectors 1010 mounted thereto that, when engaged with the connector strips 110, support the wall panels 1000 in an upright orientation. Like the connector strips 110, each connector 1010 comprises a Z-shaped cross-section, for example, but could comprise any suitable configuration.

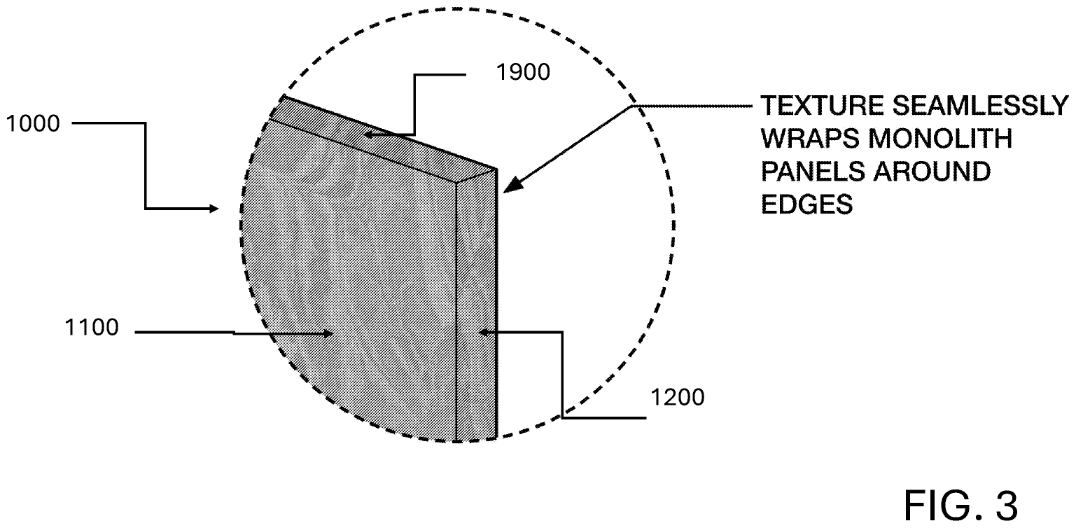

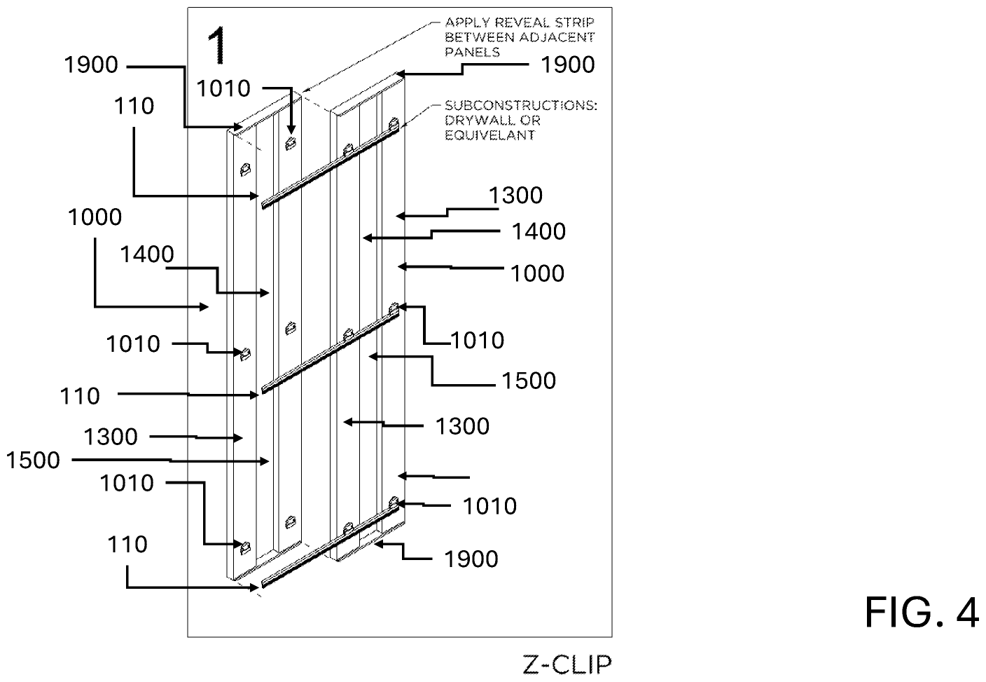

Referring to FIGS. 3-8, an acoustic wall panel 1000 comprises a front panel 1100 and two side panels 1200—each extending rearwardly from a lateral side of the front panel 1100. The acoustic wall panel 1000 further comprises two rear panels 1300—each extending inwardly from a side panel 1200—and two connecting panels 1400 extending from the rear panels 1300 that are connected to the front panel 1100, as discussed further below. The acoustic wall panel 1000 further comprises two interior spaces, or plenums, 1600 defined therein. Each plenum 1600 is defined between the front panel 1100, a side panel 1200, a rear panel 1300, and a connecting panel 1400. The acoustic wall panel 1000 further comprises end panels 1900 that enclose the plenums 1600. Air is present in the plenums 1600 but the plenums 1600 are otherwise empty. Sound waves passing through the front panel 1100, the side panels 1200, the rear panels 1300, the connecting panels 1400, and/or the end panels 1900 into the plenums 1600 can be at least partially absorbed and dissipated when the sound waves within the plenums 1600 contact the walls defining the plenums 1600, which can provide a high the Noise Reduction Coefficient (NRC) for the acoustic panel 1000.

Referring again to FIGS. 3-8, an acoustic wall panel 1000 further comprises a partially enclosed space, or plenum, 1500 defined between the front panel 1100, the connecting panels 1400, and the end panels 1900. Sound waves passing through the front panel 1100, the connecting panels 1400, and/or the end panels 1900 into the plenum 1500 can be at least partially absorbed and dissipated when the sound waves within the plenum 1500 contact the walls of the acoustic wall panel 1000 defining the plenum 1500. In addition, sound waves exiting the rear of the plenum 1500 can reflect off of the wall substrate W and back into the plenum 1500 so that they can be absorbed and dissipated by the walls of the acoustic wall panel 1000 defining the plenum 1500. Such an arrangement can provide a high the Noise Reduction Coefficient (NRC) for the acoustic panel 1000.

Further to the above, the plenum 1500 and the plenums 1600 of an acoustic wall panel 1000 all have the same, or at least substantially the same, height. In various embodiments, the acoustic wall panel 1000 is between 60″ and 116″ tall, for example, and the height of the plenums 1500 and 1600 are about the same height as the acoustic wall panel 1000. That said, embodiments are envisioned in which the acoustic wall panel 1000 is shorter than 60″ while other embodiments are envisioned in which the acoustic wall panel 1000 is taller than 116″. The plenum 1500 and the plenums 1600 of an acoustic wall panel 1000 all have the same, or at least substantially the same, lateral width. In various embodiments, the acoustic wall panel 1000 is 24″ wide and the plenums 1500 and 1600 are about 8″ wide each, for example. In various other embodiments, the acoustic wall panel 1000 is wider than 24″ and the plenums 1500 and 1600 each have a width equaling about ⅓ the width of the acoustic wall panel 1000. In other embodiments, the acoustic wall panel 1000 is 12″ wide and the plenums are about 4″ wide each, for example. In various other embodiments, the acoustic wall panel 1000 is less than 12″ wide and the plenums 1500 and 1600 each have a width equaling about ⅓ the width of the acoustic wall panel 1000.

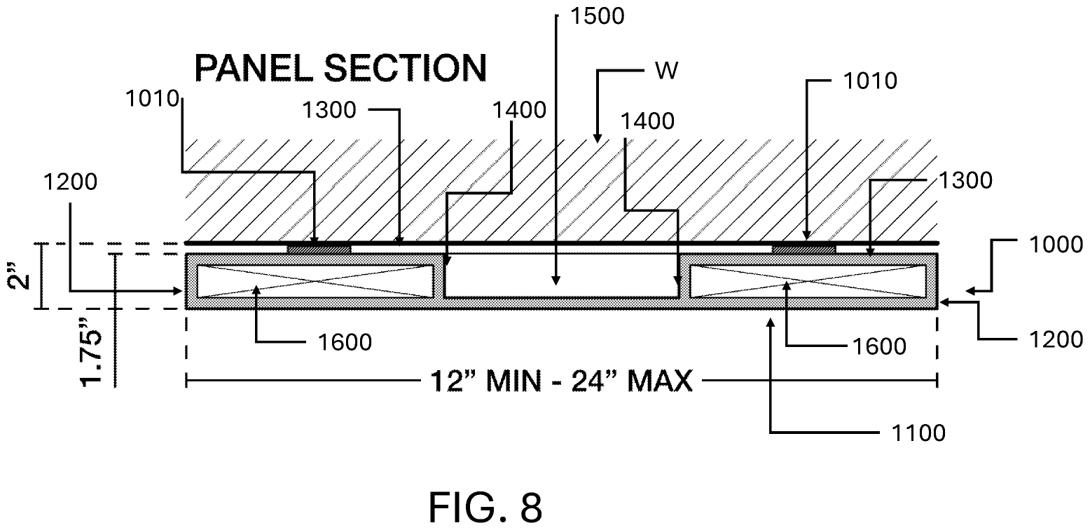

Further to the above, referring to FIG. 8, the acoustic wall panel 1000 has a thickness, or depth, of 1.75″, for example, and the plenums 1600 have a depth of less than 1.75″. That said, the plenum 1500 can have a slightly larger depth owing to its open rearward face. In various other embodiments, the acoustic wall panel 1000 and the plenums can have any suitable depths. In many respects, referring primarily to FIG. 8, the structure and configuration of the plenum 1500 and the plenums 1600 provides the acoustic wall panel 1000 with a substantially C-shaped cross-section which provides the acoustic wall panel 1000 with structural rigidity. The front panel 1100 is supported by a side panel 1200 and a connecting panel 1400 on one lateral side of the acoustic wall panel 1000 and another side panel 1200 and connecting panel 1400 on the opposite side of the acoustic wall panel 1000. A lateral expanse of the front panel 1100 extending laterally between the connecting panels 1400 is supported by the connecting panels 1400 and the end panels 1900. The connecting panels 1400 provide intermediate supports between the side panels 1200 and are evenly spaced between, or substantially evenly spaced between, the side panels 1200. Such an arrangement allows the acoustic wall panel 1000 to withstand compressive forces without deflecting significantly. That said, an acoustic wall panel can have any suitable shape and/or cross-section.

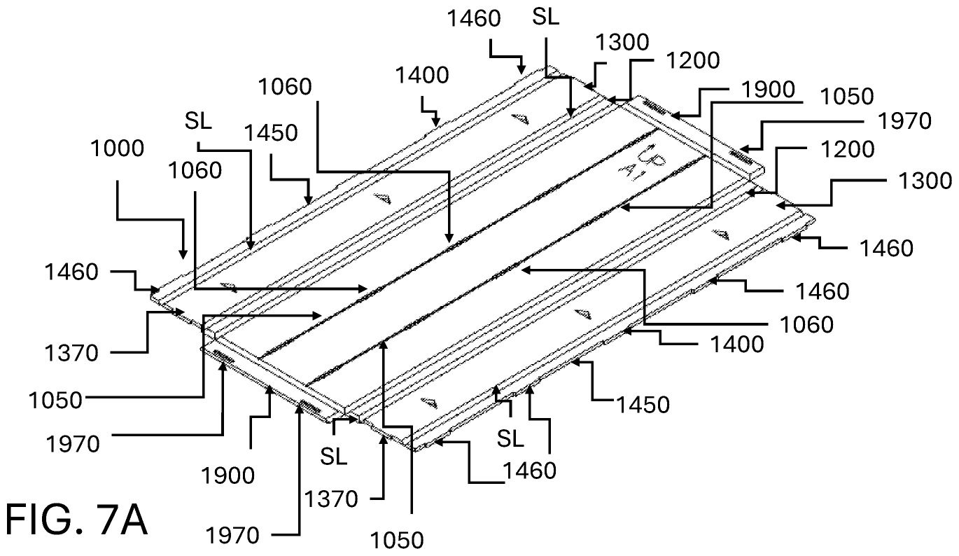

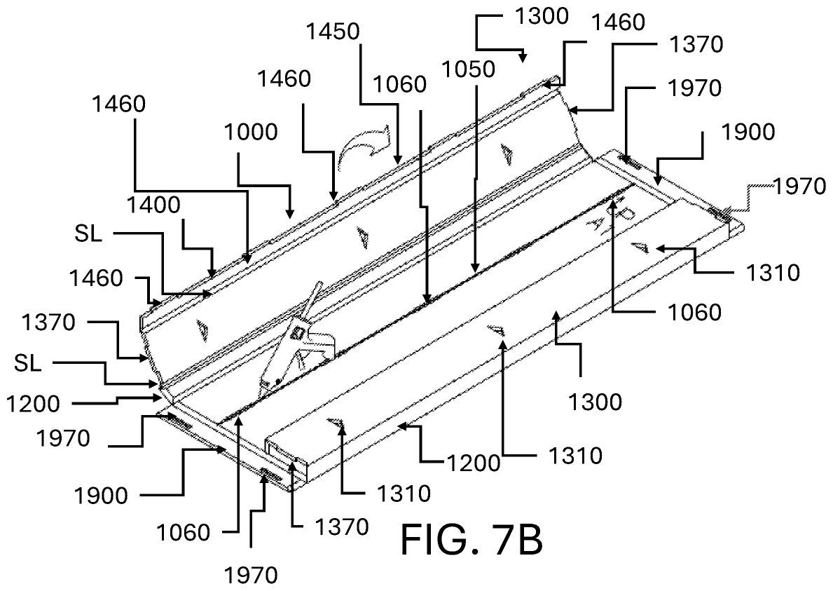

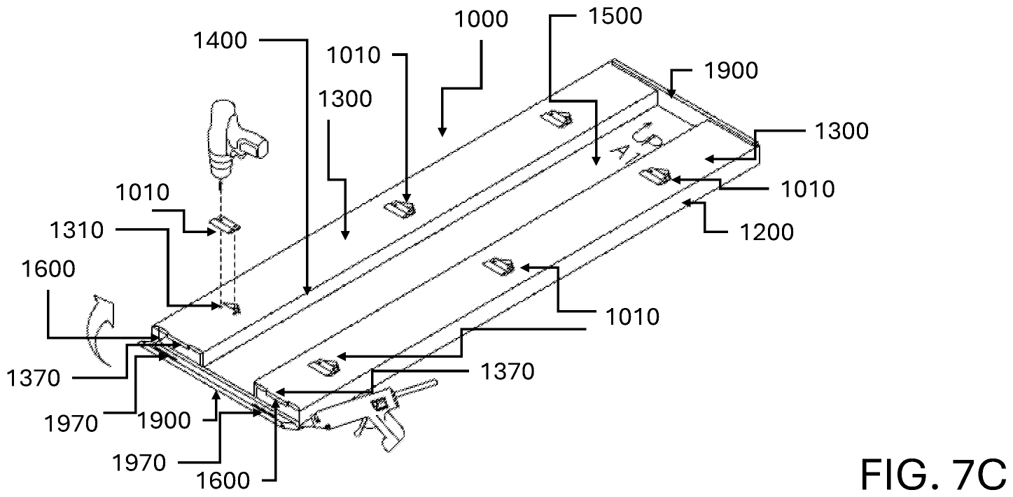

Referring to FIGS. 7A-7C, the acoustical wall panel 1000 is folded into shape from a single piece of material. FIG. 7A illustrates the piece of material in an unfolded configuration. The back side of the sheet of material comprises score lines SL that facilitate the side panels 1200 to fold relative to the front panel 1100, the rear panels 1300 to fold relative to the side panels 1200, and the connecting panels 1400 to fold relative to the rear panels 1300. The piece of material further comprises groove lines 1050 defined therein that are each configured to receive an edge 1450 of a connecting panel 1400 and tab slots 1060 positioned in the groove lines 1050 that are each configured to receive tabs 1460 extending from the connecting panels 1400, as illustrated in FIG. 7B, and lock the connecting panels 1400 to the front panel 1100. Similarly, each end panel 1900 comprises tab slots 1970 defined therein that are each configured to receive tabs 1370 extending from the rear panels 1300 when the end panels 1900 are folded over to enclose the plenums 1600, as illustrated in FIG. 7C, and lock the end panels 1900 in position.

Further to the above, the tab slots 1060 are configured to closely receive the tabs 1460 and hold the connecting panels 1400 in the groove lines 1050 and, as a result, hold, or lock, the acoustic wall panel 1000 in its C-shaped configuration. Similarly, the tab slots 1970 are configured to closely receive the tabs 1370 and hold, or lock, the end panels 1900 in their folded configurations. As a result, the acoustic wall panel 1000 can hold its configuration without the assistance of fasteners which can reduce the weight of the acoustic wall panel 1000. In various other embodiments, though, fasteners could be used to hold the acoustic wall panel 1000 in its folded configuration. In addition to or in lieu of the above, one or more adhesives can be used to hold the acoustic wall panel 1000 in its folded configuration. Referring to FIG. 7B, an adhesive can be placed in the groove lines 1050, for example. Also, for example, an adhesive can be used to hold the edges of the end panels 1900 to the side panels 1200, the rear panels 1300, and/or the connecting panels 1400.

Referring again to FIG. 7B, the rear panels 1300 comprise connector mounting apertures 1310 defined therein. Referring to FIG. 7C, each connector mounting aperture 1310 is configured to receive and hold a portion of a connector 1010 therein. In various embodiments the connectors 1010 are locked into position without the use of fasteners; however, fasteners can be used in various embodiments to attach the connectors 1010 to the rear panels 1300.

As discussed above, the acoustic wall panel 1000 is comprised of a single sheet of material, but could be comprised of multiple pieces of material that are assembled together. In either event, the acoustic wall panel 1000 is comprised of a polyethylene terephthalate (PET) felt, for example, but could be comprised of any suitable material, such as one or more thermoplastic materials and/or one or more thermoset materials, for example, and/or a blend of one or more of these materials with PET. The PET felt is non-woven, but could be woven in other embodiments. The sheet of PET felt used to form the acoustic wall panel 1000 is 0.25 inches thick, for example, but could be any suitable thickness. In various embodiments, the sheet of PET felt could be 0.125 inches, 0.375 inches, or between 0.125 inches and 0.375 inches thick, for example.

Referring to FIG. 3, the acoustic wall panel 1000 comprises an aesthetic design. Such an aesthetic design can replicate the look of marble, granite, and/or wood, for example. Cut marble, for example, typically bears certain characteristics including swirls, veins, and/or striations, for example. Such swirls, veins, and/or striations are typically the result of various mineral impurities such as clay, silt, sand, iron oxides, and/or chert, for example, the patterns of which can be replicated on the acoustic wall panel 1000 through one or more printing processes, discussed further below.

As discussed above, the acoustic wall panel 1000 comprises a front panel 1100, side panels 1200, and end panels 1900. Further to the above, referring again to FIG. 3, the front side of the front panel 1100 has an aesthetic design that wraps around the sides of the acoustic wall panel 1000 onto the side panels 1200 and the end panels 1900. When the aesthetic design on the front panel 1100 replicates cut marble, for example, the swirls, veins, and/or striations on the front side of the front panel 1100 carry over onto, or wrap around onto, the side panels 1200 and the end panels 1900 to provide the acoustic wall panel 1000 with a seamless appearance that replicates the look of a natural marble slab.

Further to the above, the sheet of PET felt comprises one or more dyes, pigments, and/or colorants embedded therein to provide the acoustic wall panel 1000 with an aesthetic color. In various embodiments, a coating is applied to the sheet of PET felt that includes one or more dyes, pigments, and/or colorants. In either case, the color of the PET felt sheet can comprise a base color onto which other colors and/or patterns, via one or more inks, for example, are applied via one or more printing processes, for example. For instance, further to the above, a pattern replicating the swirls, veins, and/or striations of marble can be sprayed onto the base color. In various instances, portions of the front side surface of the PET felt sheet are not sprayed with ink such that the base color of the PET felt sheet is visible in such portions and comprises part of the overall aesthetic presentation of the acoustic wall panel 1000. In various other instances, the entire front side surface of the PET felt sheet is sprayed with one or more inks during the printing process. In such instances, the base color of the PET felt sheet may be visible through the one or more inks, depending on the thickness, color, and/or type of ink that is used.

In various embodiments, further to the above, an acoustic wall panel 1000 is sprayed with ink, for example, to look like stone. In at least one embodiment, the base color of the PET felt sheet is a color of the stone. In some embodiments, the base color of the PET felt is the base color of the stone. In at least one embodiment, the swirls, veins, and/or striations of a stone design are sprayed with ink, for example, onto the PET felt sheet where the ink has a different color or colors than the base color of the PET felt sheet. In at least one such embodiment, only a portion of the front surface of the PET felt sheet is sprayed with ink. In at least one instance, 50% or less of the front side of the PET felt sheet is sprayed with ink, for example. In other instances, 40% or less of the front side of the PET felt sheet is sprayed with ink, for example. In other instances, 30% or less of the front side of the PET felt sheet is sprayed with ink, for example. In other instances, 20% or less of the front side of the PET felt sheet is sprayed with ink, for example. In yet other instances, 10% or less of the front side of the PET felt sheet is sprayed with ink, for example.

After the ink has been sprayed onto portions the PET felt sheet, in various embodiments, a transparent protective coating can be applied to the entire PET felt sheet, i.e., the portions of the PET felt sheet that have been sprayed with ink and the portions that have not been sprayed with ink. However, such a transparent protective coating does not contain an ink and spraying the inkless protective coating onto all of the portions of the PET felt sheet-those that have been sprayed with ink and those that have not been sprayed with ink-does not change the color of either one. Thus, even after applying such a transparent coating, the PET felt sheet will still have portions that have been sprayed with ink and portions that have not been sprayed with ink.

In various instances, a PET felt sheet comprising the acoustic wall panel 1000 is sprayed with ink before the PET felt sheet is folded to form the acoustic wall panel 1000 and, in certain instances, the acoustic wall panel 1000 is sprayed with ink after it has been folded into shape to form the acoustic wall panel 1000.

In at least one embodiment, some portions of the front side of the PET felt sheet are painted such that the base color under the ink is hidden while other portions of the front side of the PET felt sheet are not painted such that the base color is not hidden in such portions.

In various embodiments, further to the above, one or more pigments are applied to an acoustic wall panel 1000 to look like stone. In at least one embodiment, the base color of the PET felt sheet is a color of the stone. In some embodiments, the base color of the PET felt is the base color of the stone. In at least one embodiment, the swirls, veins, and/or striations of a stone design are applied to the PET felt sheet using one or more pigments where the pigments have a different color or colors than the base color of the PET felt sheet. In at least one such embodiment, only a portion of the front surface of the PET felt sheet is covered in pigment. In at least one instance, 50% or less of the front side of the PET felt sheet is covered in pigment, for example. In other instances, 40% or less of the front side of the PET felt sheet is covered in pigment, for example. In other instances, 30% or less of the front side of the PET felt sheet is covered in pigment, for example. In other instances, 20% or less of the front side of the PET felt sheet is covered in pigment, for example. In yet other instances, 10% or less of the front side of the PET felt sheet is covered in pigment, for example.

After the pigment has been applied to portions the PET felt sheet, in various embodiments, a transparent protective coating can be applied to the entire PET felt sheet, i.e., the portions of the PET felt sheet that have been covered in pigment and the portions that have not been covered in pigment. However, such a transparent protective coating does not contain a pigment and applying the pigmentless protective coating onto all of the portions of the PET felt sheet-those that have been covered in pigment and those that have not been covered in pigment-does not change the color of either one. Thus, even after applying such a transparent coating, the PET felt sheet will still have portions that have been coated with pigment and portions that have not been coated with pigment.

In at least one embodiment, some regions of the front side of the PET felt sheet are printed on with a design such that the base color under the ink is hidden while other regions of the front side of the PET felt sheet are unprinted with a design such that the base color is not hidden in such regions.

In various embodiments, further to the above, one or more regions of an acoustic wall panel 1000 are printed on with a design to look like stone. In at least one embodiment, the base color of the PET felt sheet is a color of the stone. In some embodiments, the base color of the PET felt is the base color of the stone. In at least one embodiment, the swirls, veins, and/or striations of a stone design are printed on the PET felt sheet that have a different color or colors than the base color of the PET felt sheet. In at least one such embodiment, only a portion of the front surface of the PET felt sheet is printed on with a design. In at least one instance, 50% or less of the front side of the PET felt sheet is printed on with a design, for example. In other instances, 40% or less of the front side of the PET felt sheet is printed on with a design, for example. In other instances, 30% or less of the front side of the PET felt sheet is printed on with a design, for example. In other instances, 20% or less of the front side of the PET felt sheet is printed on with a design, for example. In yet other instances, 10% or less of the front side of the PET felt sheet is printed on with a design, for example.

In various embodiments, further to the above, one or more sides of a felt acoustic wall panel 1000, for example, has a design thereon comprising a plurality of zones. In various instances, the plurality of zones comprises first zones, second zones, and third zones, for example. The first zones comprise the color, or base color, of the felt. The second zones comprise a different color on the felt that is different than the base color. In various instances, the different color comprises ink printed on the felt, for example. The third zones comprise a transition between the base color and the different color. In various instances, the transition comprises yet another color printed on the felt. In certain instances, the transition partially comprises first sub-regions having the base color of the felt and second sub-regions having the different color printed thereon that are mixed or dispersed within the first sub-regions. Within these third zones, the interspersed base color sub-regions and printed color sub-regions can create the effect of a third color in the third zones.

In various embodiments, further to the above, a panel assembly system comprises a plurality of acoustic panels having a continuous design thereon. In at least one embodiment, the panel assembly system comprises a first acoustic panel and a second acoustic panel where the first acoustic panel has a first design segment printed thereon and the second acoustic panel has a second design segment printed thereon that is an extension, or continuation, of the first design segment. In various embodiments, the first and second acoustic panels are comprised of felt having the same base color. In other embodiments, the first acoustic panel is comprised of felt having a first base color and the second acoustic panel is comprised of felt having a second base color, or a different base color than the first base color. In either case, the first design segment of the first panel and the second design segment of the second panel define, individually and/or collectively, a plurality of zones. In various instances, the plurality of zones comprises a plurality of first zones and a plurality of second zones, for example. The first zones comprise the base color of the felt of the first acoustic panel or the second acoustic panel, depending on the acoustic panel in which a first zone is defined on. The second zones comprise a different color on the felt that is different than the base color, or colors, of the first and/or second acoustic panels. In various instances, the different color on the first acoustic panel is the same as the different color on the second acoustic panel. In other instances, the different color on the first acoustic panel is different than the different color on the second panel.

After regions of the PET felt sheet have been printed on, further to the above, a transparent protective coating can be applied to the entire PET felt sheet, i.e., the regions of the PET felt sheet that have been printed on with a design and the regions that have not been printed on with a design. However, such a transparent protective coating does not contain a colorant and applying the pigmentless protective coating onto all of the regions of the PET felt sheet-those that have been printed on with a design and those that have not been printed on with a design-does not change the color of either one. Thus, even after applying such a transparent coating, the PET felt sheet will still have regions that have been printed on with a design and regions that have not been printed on with a design.

In various embodiments, further to the above, an acoustic wall panel disclosed herein can have a design that replicates wood.

In various embodiments, further to the above, one or more sides of a felt acoustic wall panel 1000, for example, has a wood grain design thereon. In various instances, the wood grain comprises a longitudinal arrangement of lines that simulate layers of wood fibers, for example. In various instances, the wood grain comprises a straight grain and/or a cross grain. A straight grain comprises straight lines, curved lines, parallel lines, and/or non-parallel lines that extend generally along the longitudinal axis of an acoustic panel. In at least one such instance, an acoustic panel comprises a height extending between the ceiling of a room and the floor, a width that extends laterally relative to the height, and a longitudinal straight wood grain axis extending between the top of the acoustic panel adjacent the ceiling and the bottom of the acoustic panel adjacent the floor. A cross grain deviates from a longitudinal axis. In various instances, a cross grain can comprise a spiral grain and/or a diagonal grain, for example, and the amount of the deviation of the cross grain from the longitudinal axis can be defined by a grain slope. The grain lines of a wood grain can extend continuously along or across an acoustic panel and can contain various irregularities such as a crotch, for example, which signifies the separation of a large branch of a tree from the trunk. In various instances, the wood grain can include irregularities such as knots and/or burls, for example.

In various embodiments, an acoustic panel system comprises a plurality of acoustic panels having a wood grain design that continues, or extends, across multiple panels. In at least one such embodiment, the wood grain design on a first acoustic panel is different than, although an extension of, the wood grain design on an adjacent second acoustic panel. In at least one embodiment, a first acoustic panel comprises a wood grain design and an adjacent second acoustic panel comprises the same wood grain design. In at least one embodiment, a first acoustic panel comprises a wood grain design and an adjacent second acoustic panel comprises a mirror image of the wood grain design.

In various embodiments, further to the above, a wood grain design of an acoustic panel, or acoustic panels, can comprise grain lines and zones between the grain lines. For instance, a wood grain design can comprise a first grain line, a second grain line, a third grain line, a first zone intermediate the first grain line and the second grain line, and a second zone intermediate the second grain line and the third grain line. In various instances, the first, second, and third grain lines are created by an ink applied to a felt surface of the acoustic panel, for example. The first, second, and third grain lines can be made from the same color ink or different color inks. The first zone can comprise the base color of the felt and/or can be at least partially covered with one or more inks, for example. Likewise, the second zone can comprise the base color of the felt and/or can be at least partially covered with one or more inks, for example.

In various embodiments, further to the above, a single layer of ink can sprayed onto the front side surface of the PET felt to create the aesthetic design of the acoustic wall panel 1000. In such embodiments, the layer of ink can be flat, or at least substantially flat. In other embodiments, multiple layers of ink are selectively overlayed onto one another and can be used to create and/or enhance a three-dimensional effect on the acoustic panel 1000. In at least one such embodiment, certain portions of the front surface of the PET felt sheet have one layer of ink printed thereon, two layers of ink printed thereon, three layers of ink printed thereon, or no layers of ink printed thereon, for example.

As discussed above, one or more inks and/or colorants can be sprayed onto the front side of the PET felt sheet. Although a spraying process is described herein, any suitable printing process can be used such as print rolling and/or print screening, for example. In various embodiments, one or more inks and/or colorants can be sprayed onto the opposite, or back, side of the PET felt sheet. In certain embodiments, a sound absorbing coating can be sprayed onto and/or otherwise applied to the back side of the PET felt sheet which can increase the NRC of the acoustic wall panel 1000.

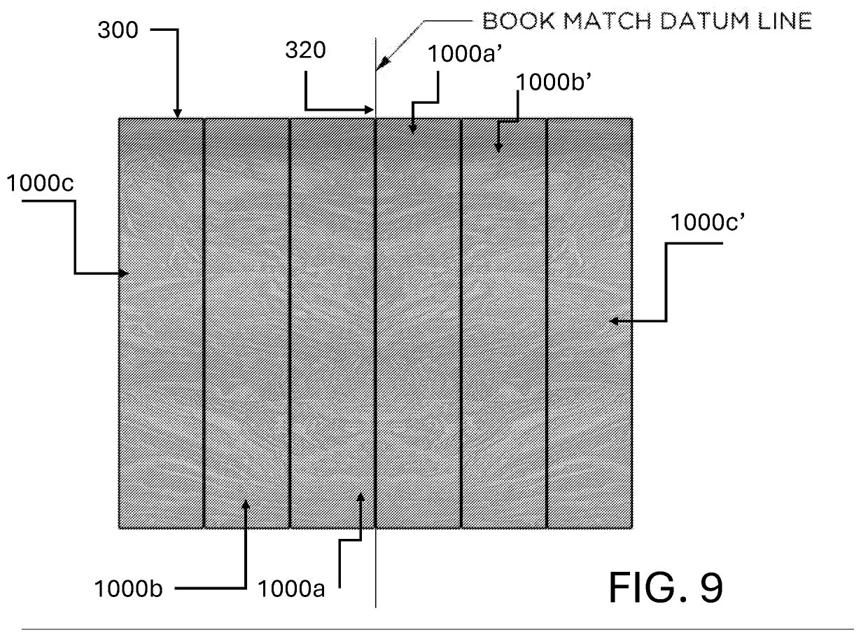

Further to the above, a panel assembly system 300 is illustrated in FIG. 9. The panel assembly system 300 is similar to the panel assembly system 100 in many respects and comprises six acoustic wall panels 1000, for example. That said, none of the six acoustic wall panels 1000 are identical to one another. More specifically, each of the six acoustic wall panels 1000 has a different aesthetic design printed thereon. As such, each of the six acoustic wall panels 1000 has been labeled with a different reference character, i.e., 1000a, 1000a′, 1000b, 1000b′, 1000c, and 1000c′. The acoustic wall panels 1000a and 1000a′ are positioned adjacent to a reflection line 320, the acoustic wall panels 1000b and 1000b′ are positioned laterally outwardly with respect to the acoustic wall panels 1000a and 1000a′, respectively, and the acoustic wall panels 1000c and 1000c′ are positioned laterally outwardly with respect to the acoustic wall panels 1000b and 1000b′, respectively. The above being said, the designs printed on the acoustic wall panels 1000a-1000c and 1000a′-1000c′ are part of a book match set where the acoustic wall panels 1000a-1000c comprise a left page and the acoustic wall panels 1000a′-1000c′ comprise a right page that is a mirror image of the left page centered about the reflection line 320.

In various embodiments, further to the above, the mirror image between the acoustic wall panel sets 1000a-1000c and 1000a′-1000c′ is an identical mirror image. In such instances, the acoustic wall panel 1000a has an identical mirror image to the acoustic wall panel 1000a′, the acoustic wall panel 1000b has an identical mirror image to the acoustic wall panel 1000b′, and the acoustic wall panel 1000c has an identical mirror image to the acoustic wall panel 1000c′. That said, other embodiments are envisioned in which the mirror image between the acoustic wall panel sets 1000a-1000c and 1000a′-1000c′ is not a perfect mirror image. In such embodiments, imperfections and/or variations in the images printed thereon can have intentional differences therein to provide the panel assembly system 300 with a more natural look. For instance, some grain structures in the design printed on the acoustic wall panels 1000a-1000c can be slightly different than the grain structures in the design printed on the acoustic wall panels 1000a′-1000c′.

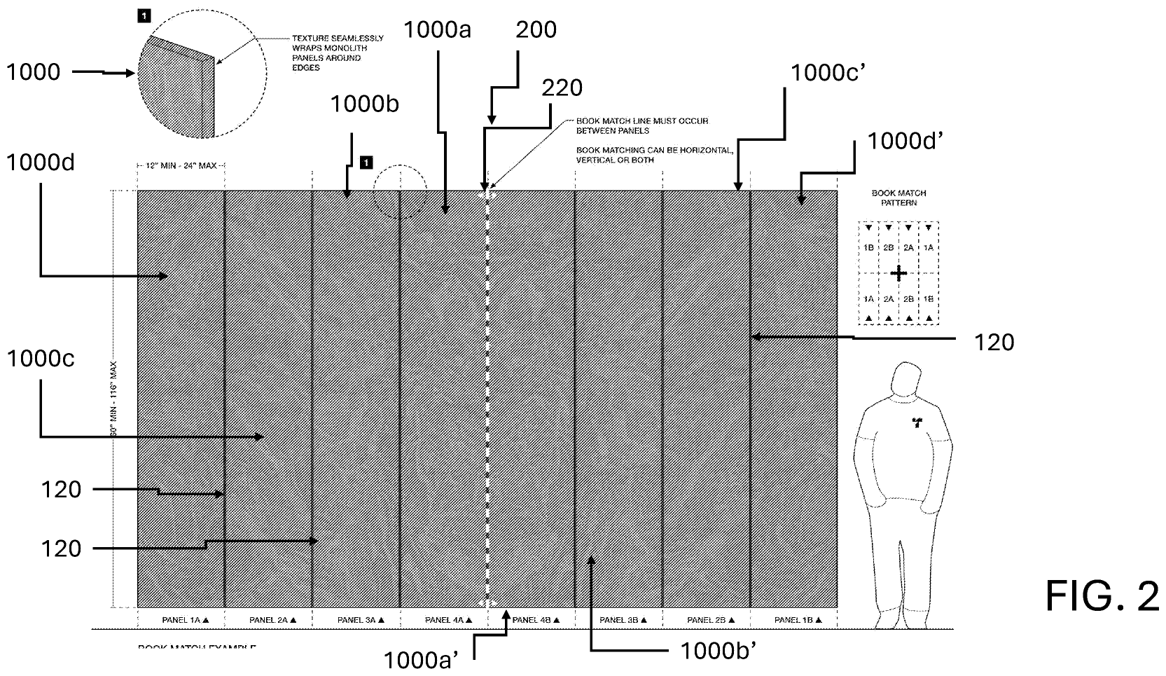

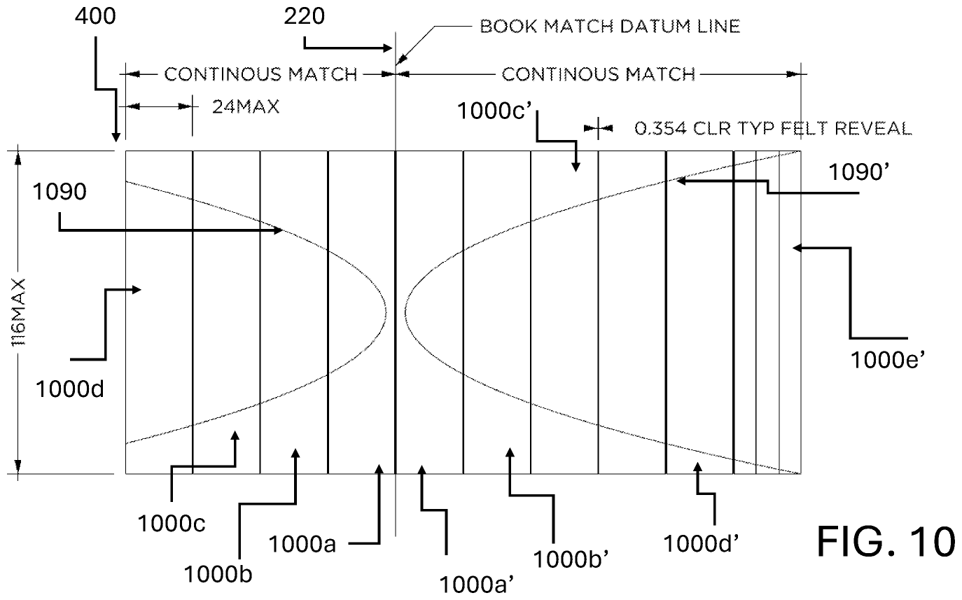

Another wall panel assembly system 200 is illustrated in FIG. 2. The wall panel assembly system 200 is similar to the wall panel assembly system 300 in many respects and includes eight acoustic wall panels 1000, i.e., acoustic wall panels 1000a-1000c and 1000a′-1000c′ as well as acoustic wall panels 1000d and 1000d′. The acoustic wall panel 1000d extends the left book image another panel laterally to the left and the acoustic wall panel 1000d′ extends the right book image another panel laterally to the right. Another wall panel assembly system 400 is illustrated in FIG. 10. The wall panel assembly 400 is similar to the wall panel assembly systems 200 and 300 in many respects and includes another acoustic wall panel 1000e′ that extends the right book image another panel laterally to the right. As a result of the above, the right book image 1090′ on the panels 1000a′-1000e′ is laterally wider than the left book image 1090 on the panels 1000a-1000d.

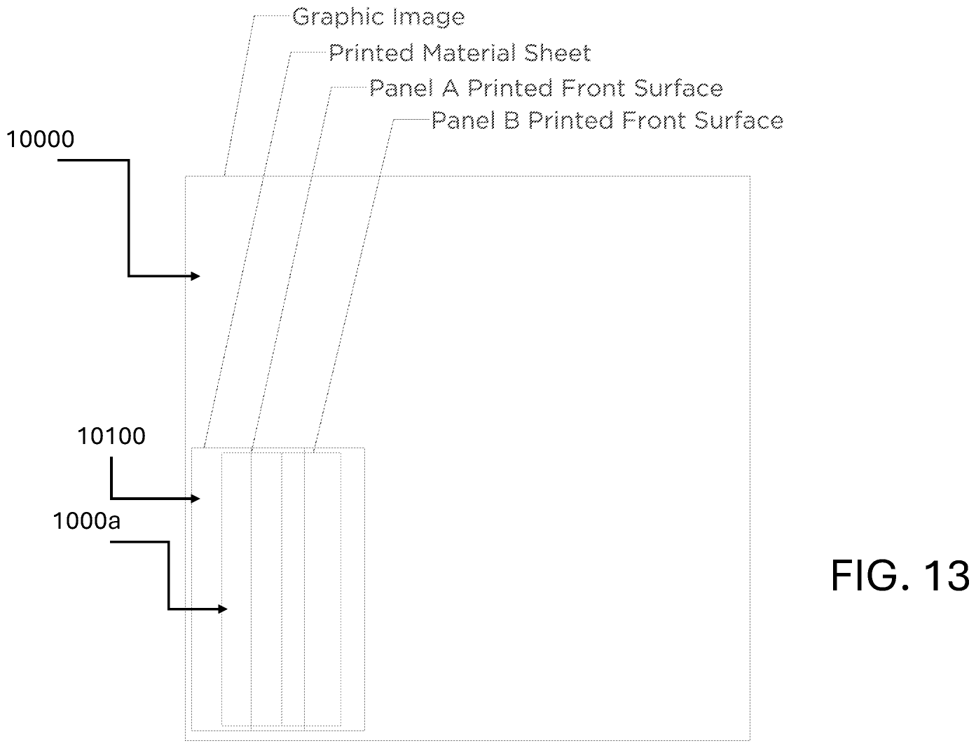

Further to the above, the images printed on the acoustic wall panels 1000a-1000d and 1000a′-1000e′, for example, are portions of a larger graphic image labeled 10000 in FIG. 13. FIG. 13 illustrates part of a planning step that occurs prior to manufacturing the acoustic wall panels 1000a-1000d and 1000a′-1000e′. In this step, an image region 10100 is selected from the larger graphic image 10000 that has the same size as the sheet of PET felt that will be used to make the acoustic wall panel 10000a, for example. During the printing process, the image region 10100 is printed on a sheet of PET felt and, thereafter, the sheet of PET felt is folded to form the acoustic wall panel 1000a, as described above. A similar process is used to create the acoustic wall panels 1000b-1000d, for example. As a result of the above, a continuous image can be portrayed across the acoustic wall panels 1000a-1000d giving the effect of the acoustic wall panels 1000a-1000d having been cut from a single slab of stone, for example. A similar result can be created for the acoustic wall panels 1000a′-1000e′ using the same, or a similar, process.

In various embodiments, as a result of the above, the front panels 1100 of the acoustic wall panels 1000 of a wall panel assembly system comprise a continuous, or an at least substantially continuous, image across the front faces thereof. Moreover, as discussed above, each acoustic wall panel 1000 comprises a continuous, or at an at least substantially continuous, image extending from the front face of its front panel 1100 around to its side panels 1200 and its end panels 1900. In various instances, referring again to FIG. 1, a gap 120 is defined between adjacent acoustic wall panels 1000. In at least one instance, the gaps 120 are 0.354″ wide, but can be any suitable width. As a result, the side panels 1200 of the acoustic wall panels 1000 can be visible to an observer via the gaps 120 and the continuous image between the front panel 1100 and the side panels 1200 of an acoustic wall panel 1000 can be aesthetic to the observer.

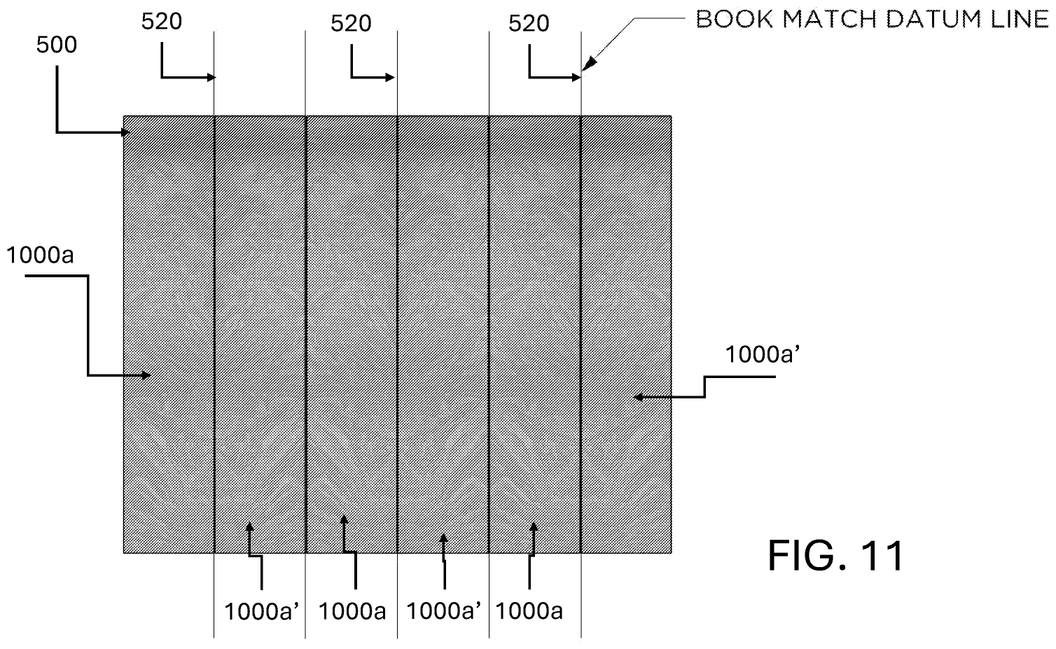

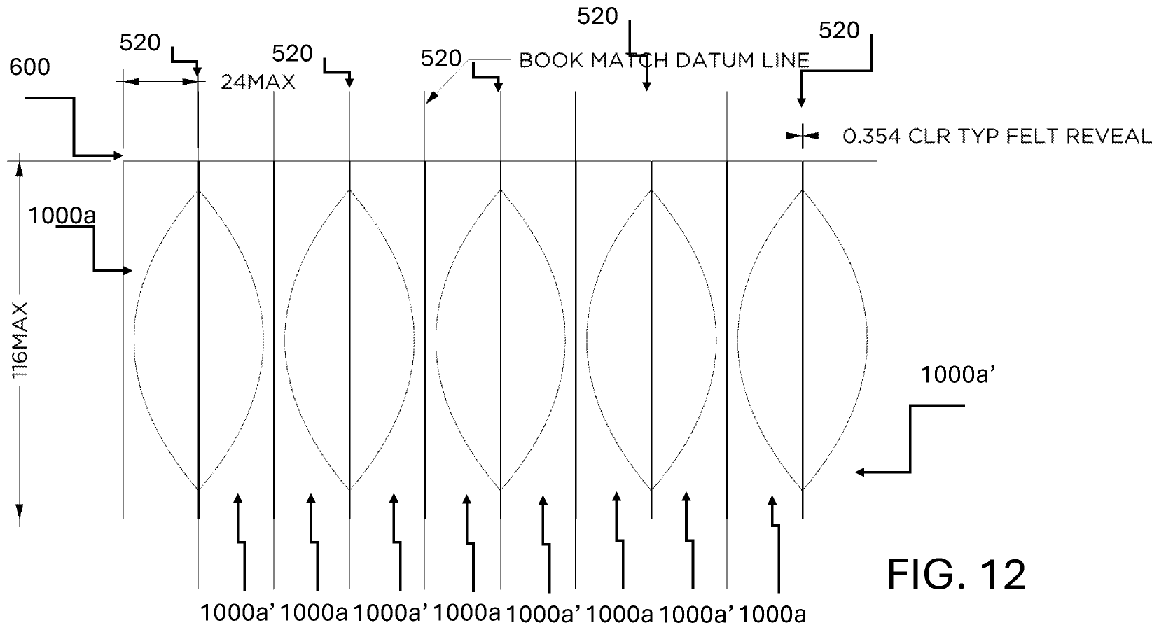

Another wall panel assembly system 500 is illustrated in FIG. 11. The wall panel assembly system 500 is similar to the wall panel assembly systems 100, 200, 300, and 400 in many respects. Similar to the wall panel assembly system 100, the wall panel assembly system 500 comprises six acoustic panels 1000; however, the wall panel assembly system 500 comprises three acoustic panels 1000a and three acoustic panels 1000a′. The acoustic panels 1000a and 1000a′ are arranged laterally in an alternating manner such that each pair of acoustic panels 1000a and 1000a′ comprise a book match set having mirror images, or at least substantially mirror images, relative to a reflection line, or datum, 520. Another wall panel assembly system 600 is illustrated in FIG. 12 having five book matched sets of acoustic wall panels 1000a and 1000a′, but a wall panel assembly system can have any suitable number of book matched sets.

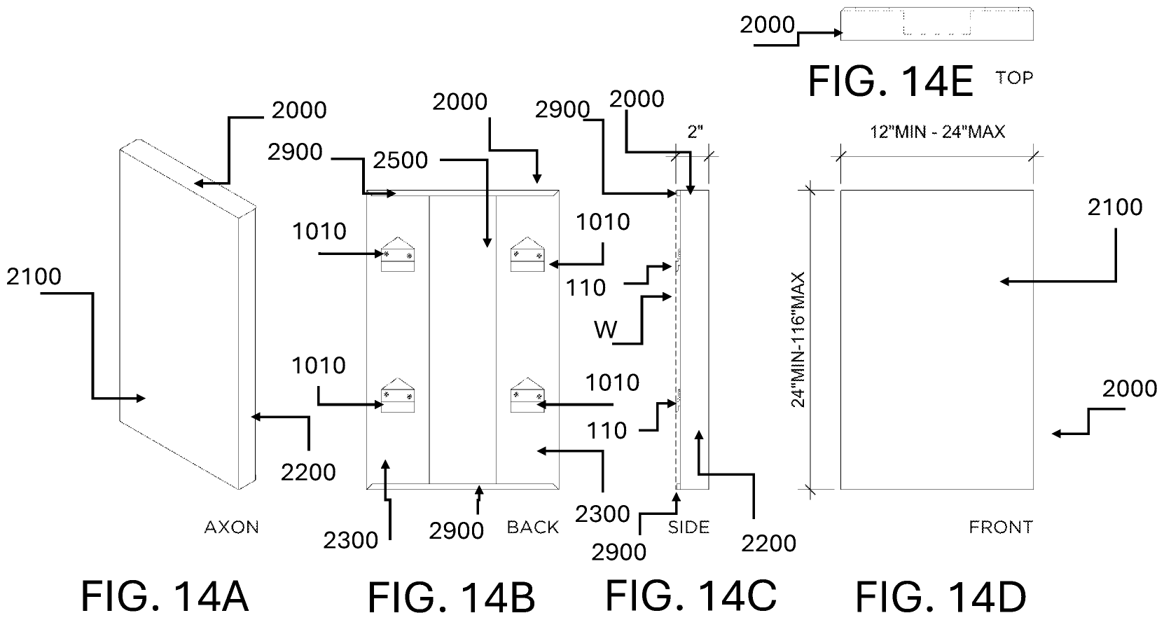

An acoustic wall panel 2000 is illustrated in FIGS. 14A-14E. The acoustic wall panel 2000 is similar to the acoustic wall panel 1000 in many respects. The acoustic wall panel 2000 comprises a front panel 2100, side panels 2200, rear panels 2300, and connecting panels that connect the rear panels 2300 to the back side of the front panel 2100. Similar to the acoustic wall panel 1000, the front panel 2100, the side panels 2200, the rear panels 2300, and the connecting panels define interior spaces, or plenums, and the acoustic wall panel 2000 further comprises end panels 2900 that have been folded over to enclose the plenums. Also similar to the acoustic wall panel 1000, the acoustic wall panel 2000 comprises an unenclosed interior space, or plenum, 2500 defined between the connecting panels. The end panels 2900 extend rearwardly, or overhang, relative to the rear panels 2300. When the acoustic wall panel 2000 is connected to and supported by connector rails 110 mounted to a wall substrate W, the end panels 2900 are in contact with the wall substrate W. In at least one such embodiment, the gap between the rear walls 2300 and the wall substrate W is 0.25″, for example, and the end panels 2900 extend 0.25″ rearwardly behind the rear panels 2300 such that there is no gap between the end panels 2900 and the wall substrate W. It should be appreciated, however, that wall substrates are rarely, if ever, flat and, as a practical matter, gaps may exist between the end panels 2900 and the wall substrate W in many instances. At least in such instances, the gap between the end panels 2900 and the wall substrate W can be substantially closed. Such an arrangement can provide improved sound absorption and dissipation.

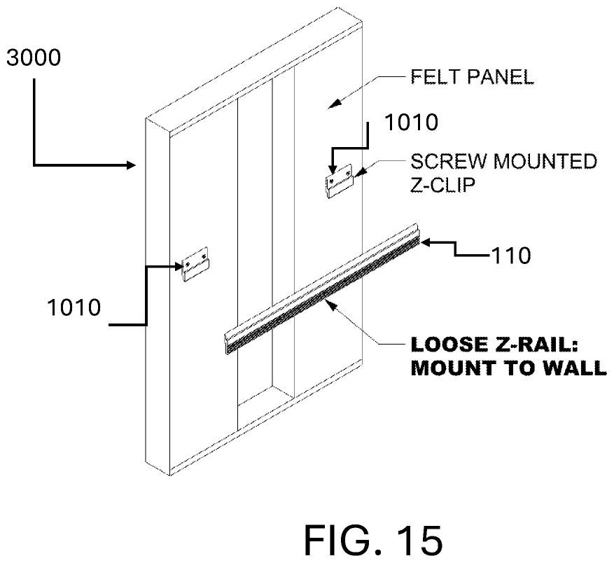

An acoustic wall panel 3000 is illustrated in FIG. 15. The acoustic wall panel 3000 is similar to the acoustic wall panel 1000 in many respects but is attachable to a wall substrate using only one connector rail 110.

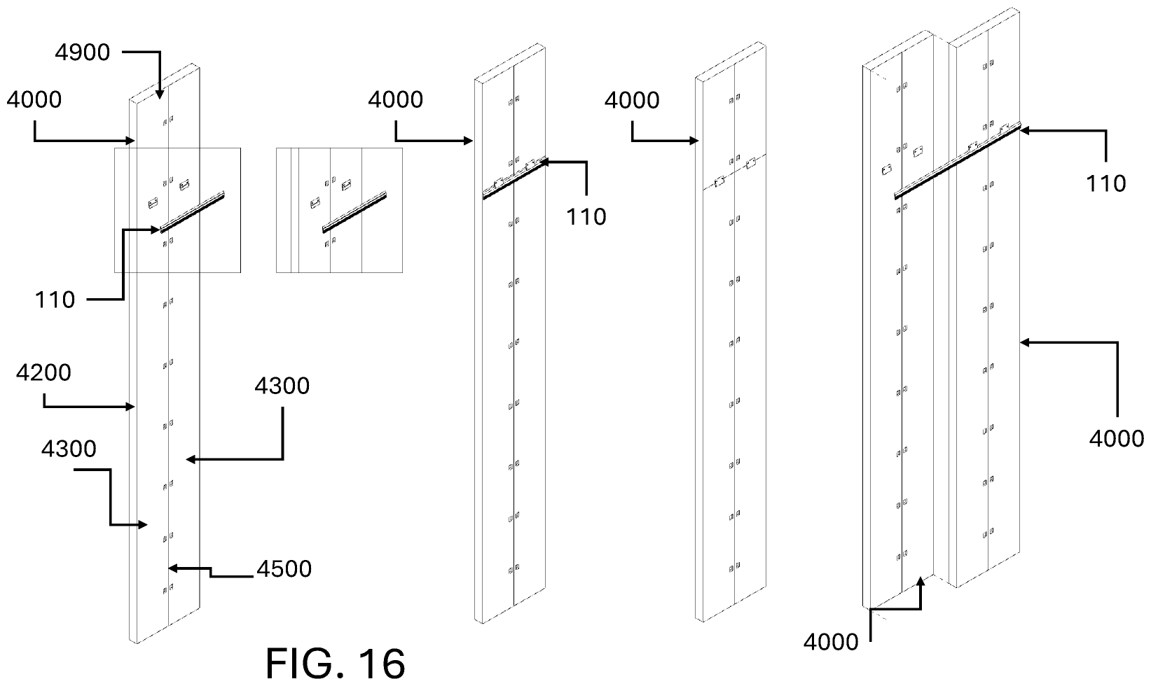

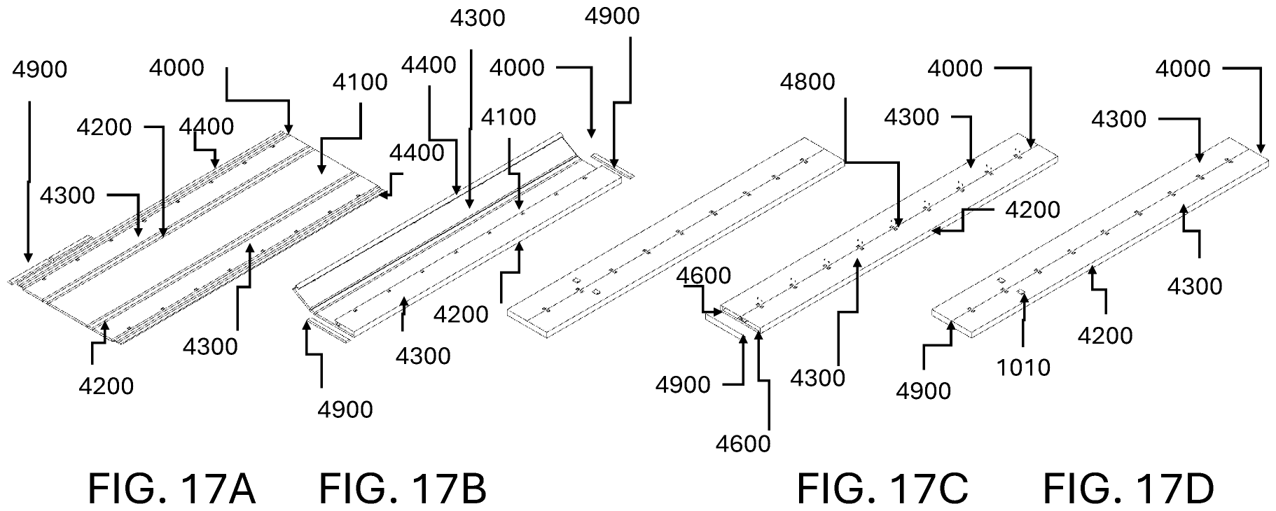

An acoustic wall panel 4000 is illustrated in FIGS. 16 and 17A-17D. The acoustic wall panel 4000 is similar to the wall panel 1000 in many respects. The acoustic wall panel 4000 comprises a front panel 4100, opposing side panels 4200, a rear panel 4300 extending inwardly from each side panel 4200, and connecting panels 4400 that connect the rear panels 4300 to the back side of the front panel 4100. Similar to the acoustic wall panel 1000, referring primarily to FIG. 17C, the front panel 4100, the side panels 4200, the rear panels 4300, and the connecting panels 4400 define spaces, or plenums, 4600 that are enclosed by end caps 4900. However, referring primarily to FIG. 17B, the end caps 4900 are not integrally formed with the rest of the acoustic wall panel 4000; rather, the end caps 4900 are assembled to the acoustic wall panel 4000. Moreover, the acoustic wall panel 4000 has a narrow gap 4500 defined between the connecting panels 4400 and does not have an expansive space, or plenum, defined between the connecting panels 4400. In various instances, the rear panels 4300 are held together by clips and/or fasteners 4800, for example.

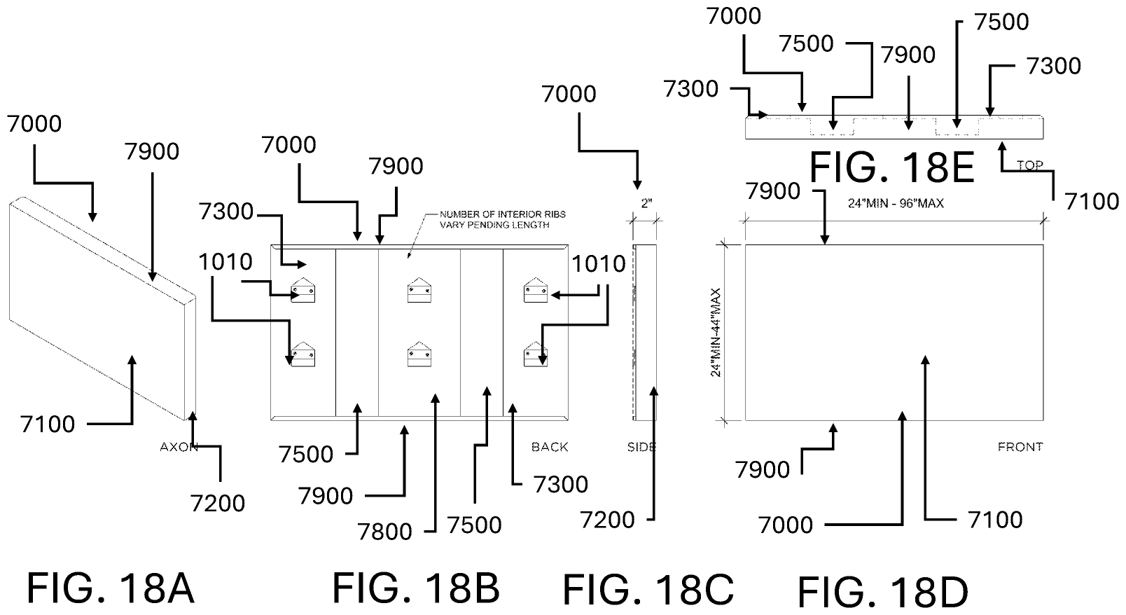

An acoustic wall panel 7000 is illustrated in FIGS. 18A-18E, 19, and 20A-20C. The acoustic wall panel 7000 is similar to acoustic wall panel 1000 in many respects. The acoustic wall panel 7000 comprises a front panel 7100 and two side panels 7200—each extending rearwardly from a lateral side of the front panel 7100. The wall panel 7000 further comprises two rear panels 7300—each extending inwardly from a side panel 7200—and two connecting panels 7400 extending from the rear panels 7300 that are connected to the back side of the front panel 7100, as discussed further below. The acoustic wall panel 7000 further comprises two interior spaces, or plenums, 7600 defined therein. Each plenum 7600 is defined between the front panel 7100, a side panel 7200, a rear panel 7300, and a connecting panel 7400. The acoustic wall panel 7000 further comprises end panels 7900 that enclose the plenums 7600. Air is present in the plenums 7600 but the plenums 7600 are otherwise empty. Sound waves passing through the front panel 7100, the side panels 7200, the rear panels 7300, the connecting panels 7400, and/or the end panels 7900 into the plenums 7600 can be at least partially absorbed and dissipated when the sound waves within the plenums 7600 contact the walls defining the plenums 7600, which can provide a high the Noise Reduction Coefficient (NRC) for the acoustic panel 7000.

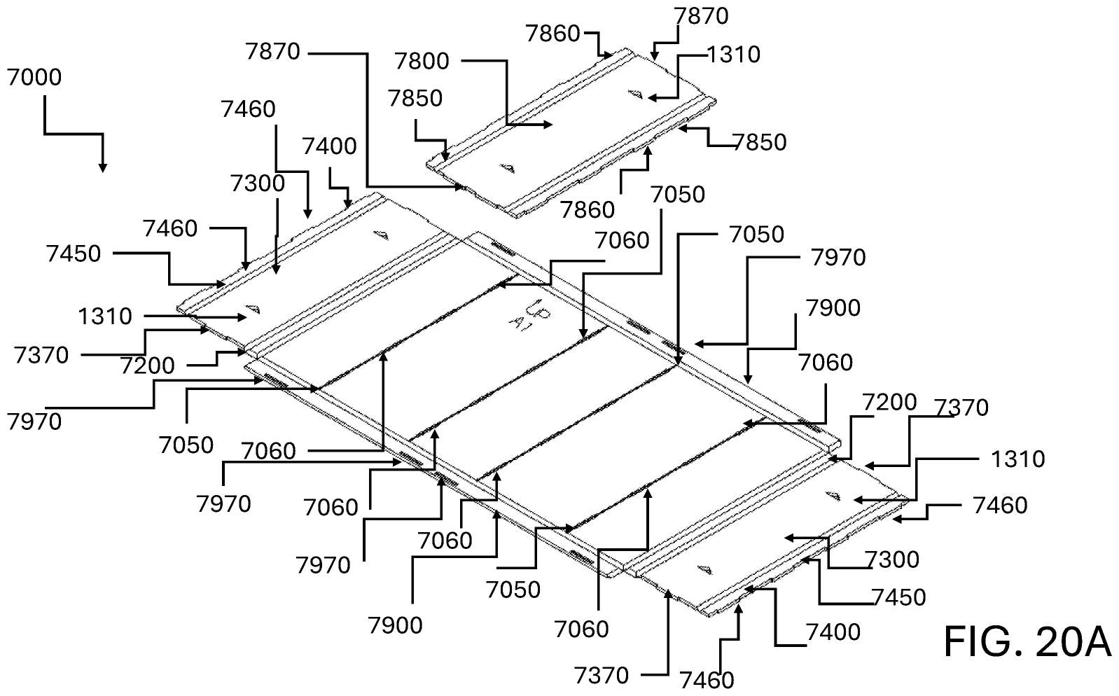

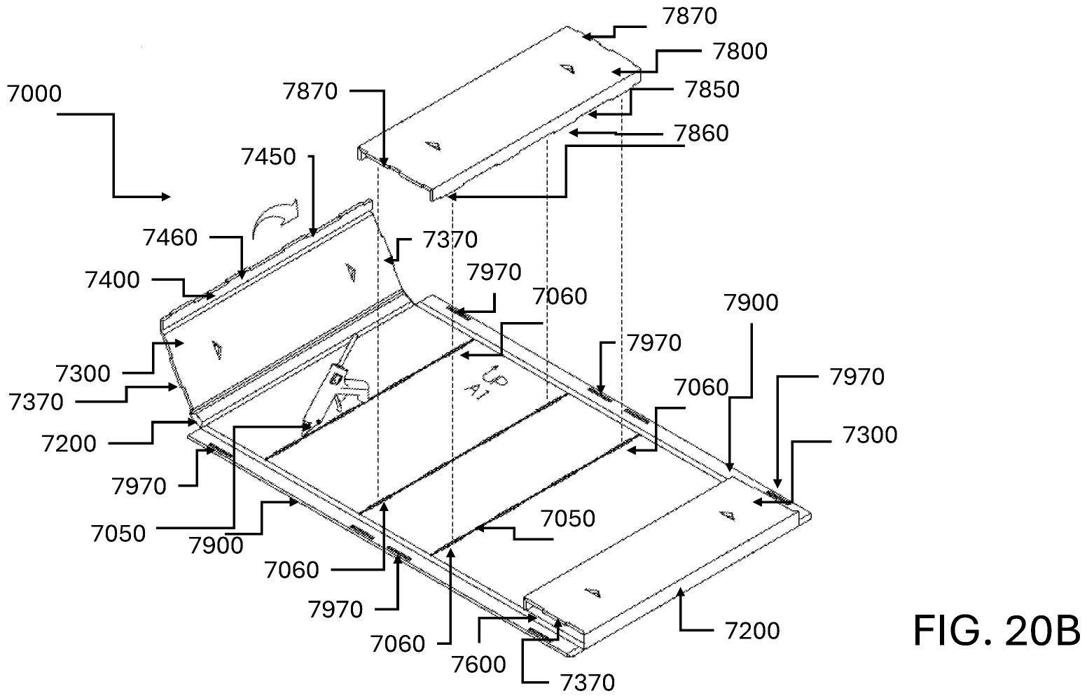

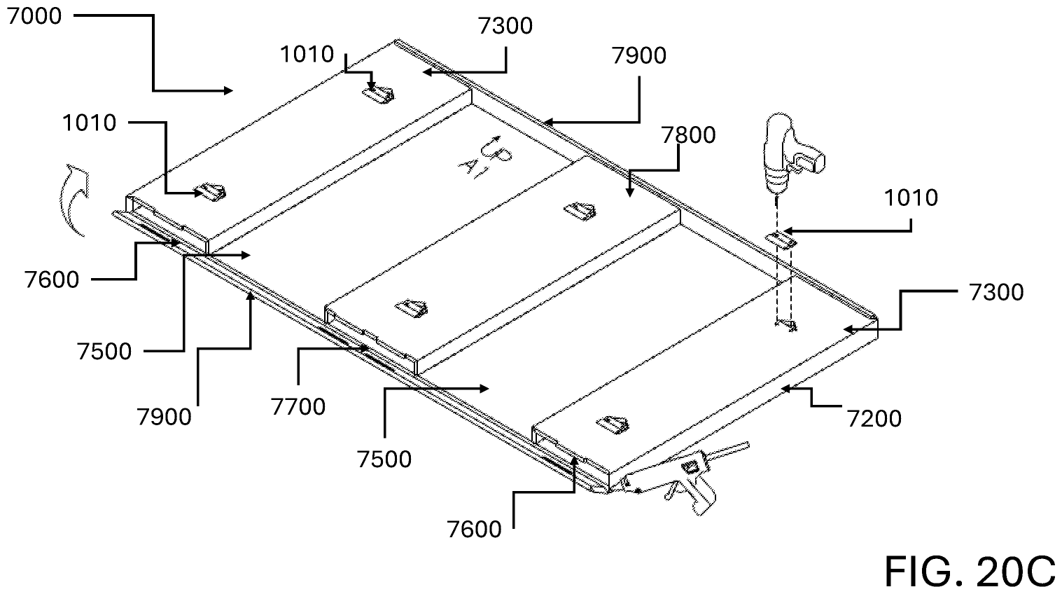

Referring primarily to FIGS. 20A-20C, the acoustic wall panel 7000 is primarily folded into shape from a single piece of material. FIG. 20A illustrates the piece of material in an unfolded configuration. The back side of the sheet of material comprises score lines that facilitate the side panels 7200 to fold relative to the front panel 7100, the rear panels 7300 to fold relative to the side panels 7200, and the connecting panels 7400 to fold relative to the rear panels 7300. The piece of material further comprises groove lines 7050 defined therein that are each configured to receive an edge 7450 of a connecting panel 7400. The piece of material also comprises tab slots 7060 positioned in the groove lines 7050 that are each configured to receive tabs 7460 extending from the connecting panels 7400, as illustrated in FIG. 20B, and lock the connecting panels 7400 to the front panel 7100. Similarly, each end panel 7900 comprises tab slots 7970 defined therein that are each configured to receive tabs 7370 extending from the rear panels 7300 when the end panels 7900 are folded over to enclose the plenums 7600, as illustrated in FIG. 20C, and lock the end panels 7900 in position.

Further to the above, the tab slots 7060 are configured to closely receive the tabs 7460 and hold the connecting panels 7400 in the groove lines 7050 and, as a result, hold, or lock, the acoustic wall panel 1000 in a folded E-shaped, or substantially E-shaped, configuration. Similarly, the tab slots 7970 are configured to closely receive the tabs 7370 and hold, or lock, the end panels 7900 in their folded configurations. As a result, the acoustic wall panel 7000 can hold its configuration without the assistance of fasteners which can reduce the weight of the acoustic wall panel 7000. In various other embodiments, though, fasteners could be used to hold the acoustic wall panel 7000 in its folded configuration. In addition to or in lieu of the above, one or more adhesives can be used to hold the acoustic wall panel 7000 in its folded configuration. Referring to FIG. 20B, an adhesive can be placed in the groove lines 7050, for example. Also, for example, an adhesive can be used to hold the edges of the end panels 7900 to the side panels 7200, the rear panels 7300, and/or the connecting panels 7400.

Referring again to FIGS. 18A-18E, 19, and 20A-20C, the acoustic wall panel further comprises a rear cover 7800 attached to the back side of the front panel 7100. The rear cover 7800, once folded into shape as illustrated in FIG. 20B, can be assembled to the front panel 7100, as illustrated in FIG. 20C. The rear cover 7800 comprises edges 7850 that are received within groove lines 7050 defined in the back side of the front panel 7100. The rear cover 7800 further comprises tabs 7860 extending from the edges 7850 that are configured to be received in tab slots 7060 defined in the groove lines 7050 and lock the rear cover 7800 to the front panel 7100. The rear cover 7800 further comprises tabs 7870 extending therefrom that are received in tabs slots 7970 in the end panels 7900 when the end panels 7900 are folded into position. The rear cover 7800 defines a space, or plenum, 7700 between the rear cover 7800 and the front panel 7100 that, similar to the plenums 7600, can absorb and dissipate sound waves.

Referring again to FIGS. 18A-18E, 19, and 20A-20C, the acoustic wall panel 7000 further comprises partially enclosed spaces, or plenums, 7500. Each plenum 7500 is defined between the front panel 7100, a connecting panel 7400, the rear cover 7800, and the end panels 7900. Sound waves passing through the front panel 7100, the connecting panels 7400, the rear cover 7800, and/or the end panels 7900 into the plenums 7500 can be at least partially absorbed and dissipated when the sound waves within the plenums 7500 contact the walls of the acoustic wall panel 7000 defining the plenums 7500. In addition, sound waves exiting the rear of the plenums 7500 can reflect off of the wall substrate W and back into the plenums 7500 so that they can be absorbed and dissipated by the walls of the acoustic wall panel 7000 defining the plenum 7500. Such an arrangement can provide a high the Noise Reduction Coefficient (NRC) for the acoustic panel 7000.

Further to the above, the plenums 7500, the plenums 7600, and the plenum 7700 of an acoustic wall panel 7000 all have the same, or at least substantially the same, height. In various embodiments, the acoustic wall panel 7000 is between 24″ and 44″ tall, for example, and the height of the plenums 7500, 7600, and 7700 is slightly shorter than the height of the acoustic wall panel 7000. That said, embodiments are envisioned in which the acoustic wall panel 7000 is shorter than 24″ while other embodiments are envisioned in which the acoustic wall panel 7000 is taller than 44″. In various embodiments, the acoustic wall panel 7000 is between 24″ and 96 inches wide. In various other embodiments, the acoustic wall panel 7000 is wider than 96″ and the plenums 7500, 7600, and 7700 each have a width equaling about ⅕ the width of the acoustic wall panel 7000, for example. In other embodiments, the acoustic wall panel 7000 is less than 24″ wide and the plenums 7500, 7600, and 7700 each have a width equaling about ⅕ the width of the acoustic wall panel 7000, for example.

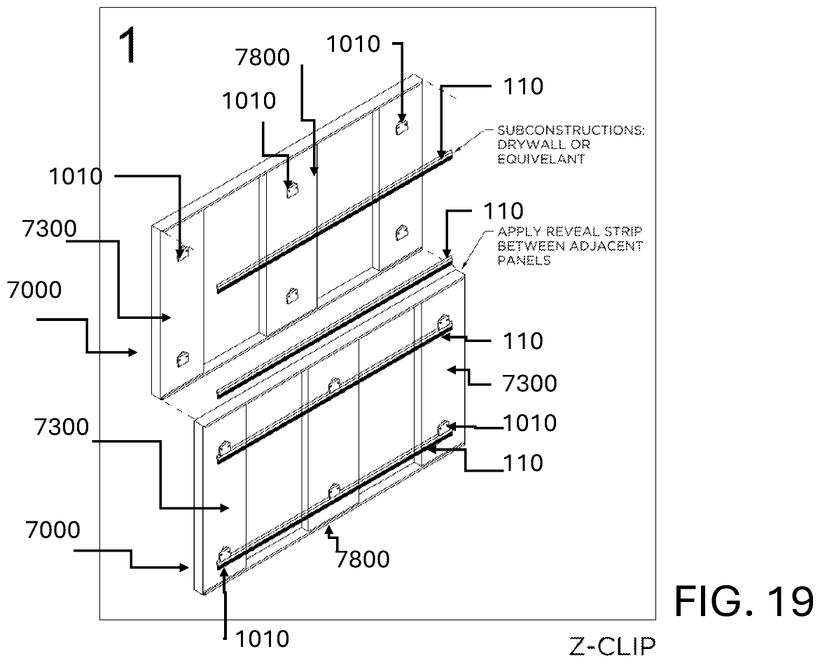

In many respects, referring primarily to FIG. 19, the structure and configuration of the side walls 7200, the rear walls 7300, the connecting walls 7400, and the rear cover 7800 provides the acoustic wall panel 7000 with a substantially E-shaped cross-section which provides the acoustic wall panel 7000 with structural rigidity. The front panel 7100 is supported by a side panel 7200 and a connecting panel 7400 on one lateral side of the acoustic wall panel 7000 and another side panel 7200 and connecting panel 7400 on the opposite side of the acoustic wall panel 7000. Similarly, the middle of the front panel 7000 is supported by the rear cover 7800. A lateral expanse of the front panel 7100 extending laterally between the side panels 7200 is supported by the connecting panels 7400 and the rear cover 7800. As a result of this arrangement, the acoustic wall panel 7000 is capable of withstanding compressive loads applied to the front panel 7100 without significantly deflecting.

Notably, further to the above, the acoustic wall panel 7000 comprises a wall panel that is oriented horizontally while the acoustic wall panel 1000 comprises a wall panel that is oriented vertically. Stated another way, the acoustic wall panel 7000 is wider than it is tall, and the acoustic wall panel 1000 is taller than it is wide. That said, various embodiments are envisioned in which the acoustic wall panels 1000 and 7000 have any suitable dimensions.

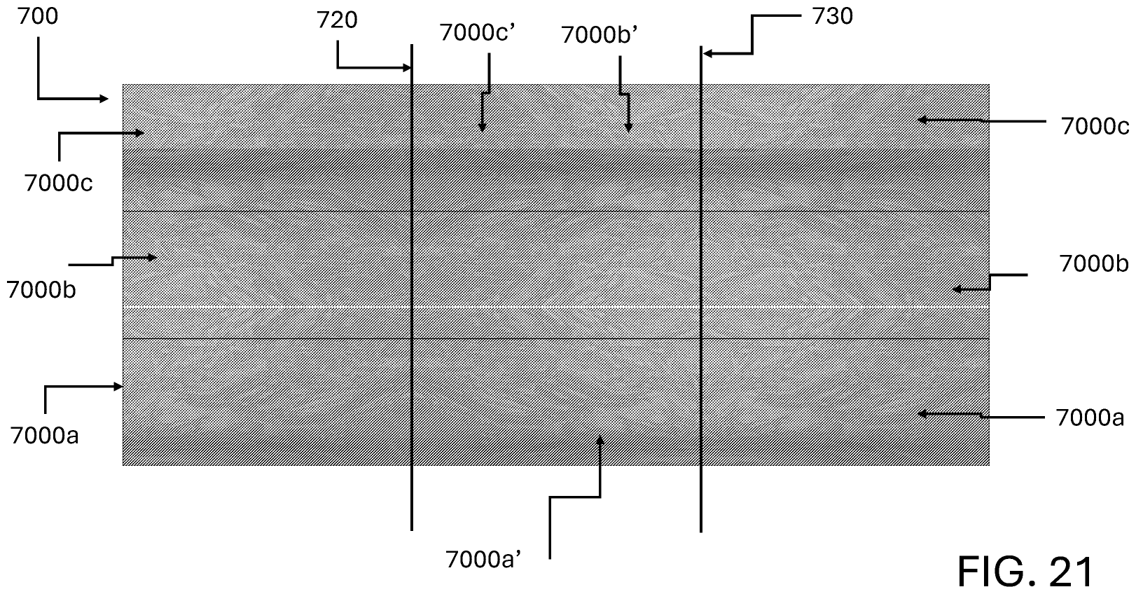

A wall panel assembly system 700 is illustrated in FIG. 21. The wall panel assembly system 700 comprises six types of acoustic wall panels 7000, for example. Each of the six types of acoustic wall panels 7000 has a different aesthetic design printed thereon. As such, each of the six types of acoustic wall panels 7000 has been labeled with a different reference character, i.e., 7000a, 7000a′, 7000b, 7000b′, 7000c, and 7000c′. The designs printed on the acoustic wall panels 7000a-7000c and 7000a′-7000c′ are part of a book match set where the acoustic wall panels 7000a-7000c comprise a left page and the acoustic wall panels 7000a′-7000c′ comprise a right page that is a mirror image of the left page centered about a reflection line 720. Moreover, as can be seen in FIG. 21, the collective design of a set of acoustic wall panels 7000a, 7000a′, 7000b, 7000b′, 7000c, and 7000c′ is repeated with respect to a reflection line 730.

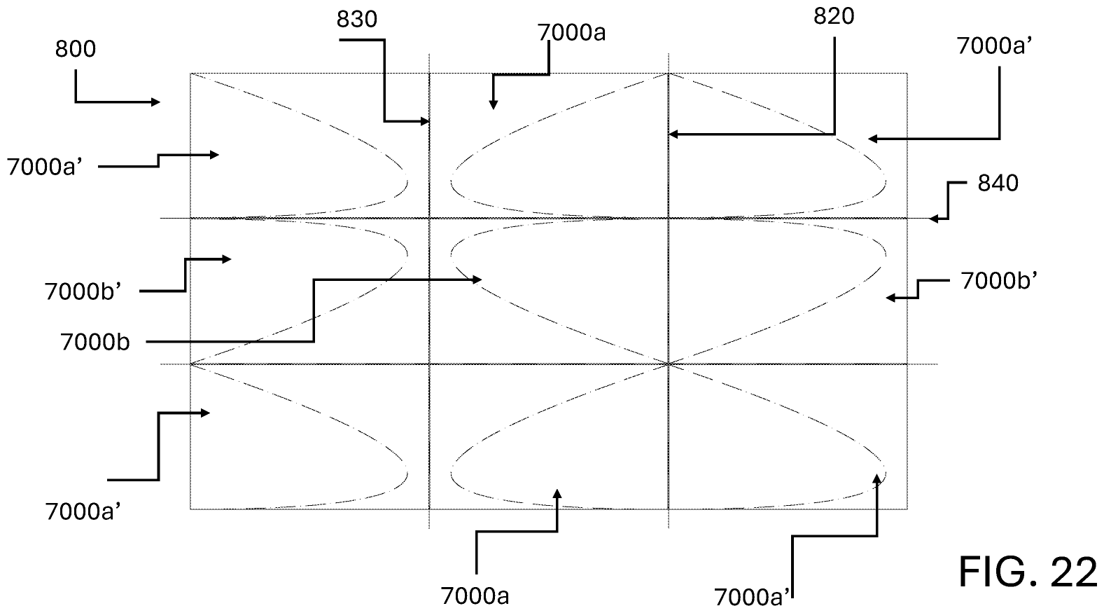

A wall panel assembly system 800 is illustrated in FIG. 22. The wall panel assembly system 800 comprises four types of acoustic wall panels 7000, for example. Each of the four types of acoustic wall panels 7000 has a different aesthetic design printed thereon. As such, each of the four types of acoustic wall panels 7000 has been labeled with a different reference character, i.e., 7000a, 7000a′, 7000b, and 7000b′. The designs printed on the acoustic wall panels 7000a-7000b and 7000a′-7000b′ are part of a book match set where the acoustic wall panels 7000a-7000b comprise a left page and the acoustic wall panels 7000a′-7000b′ comprise a right page that is a mirror image of the left page centered about a reflection line 820. Moreover, as can be seen in FIG. 22, the collective design of a set of acoustic wall panels 7000a, 7000a′, 7000b, and 7000b′, is repeated with respect to a reflection line 830 and a reflection line 840.

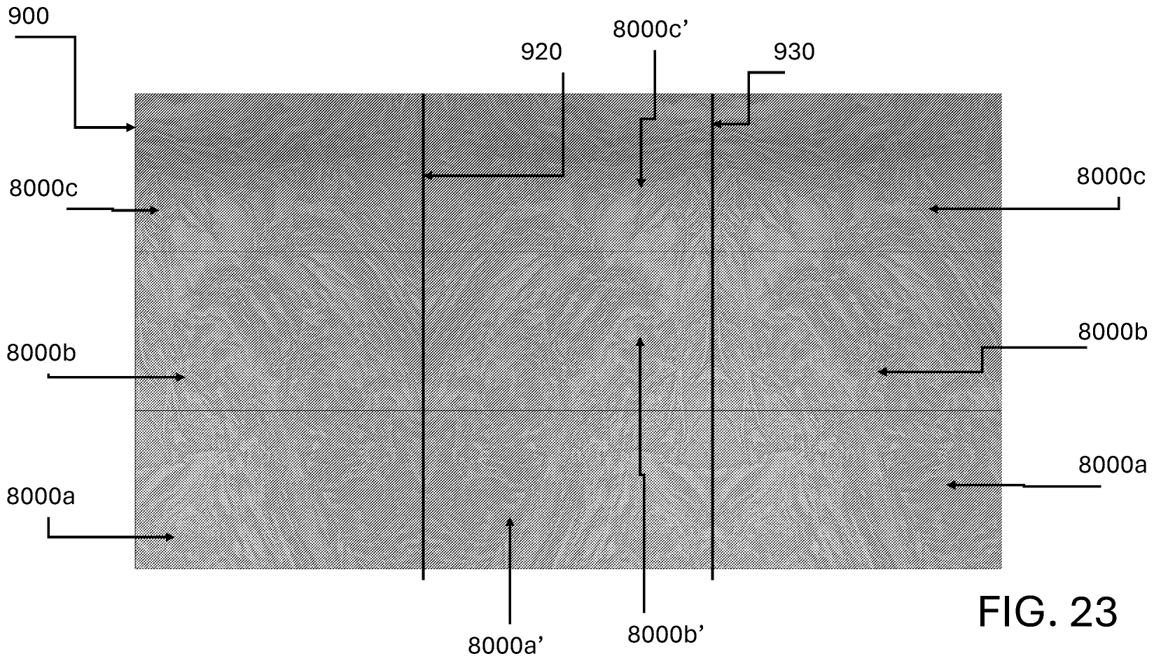

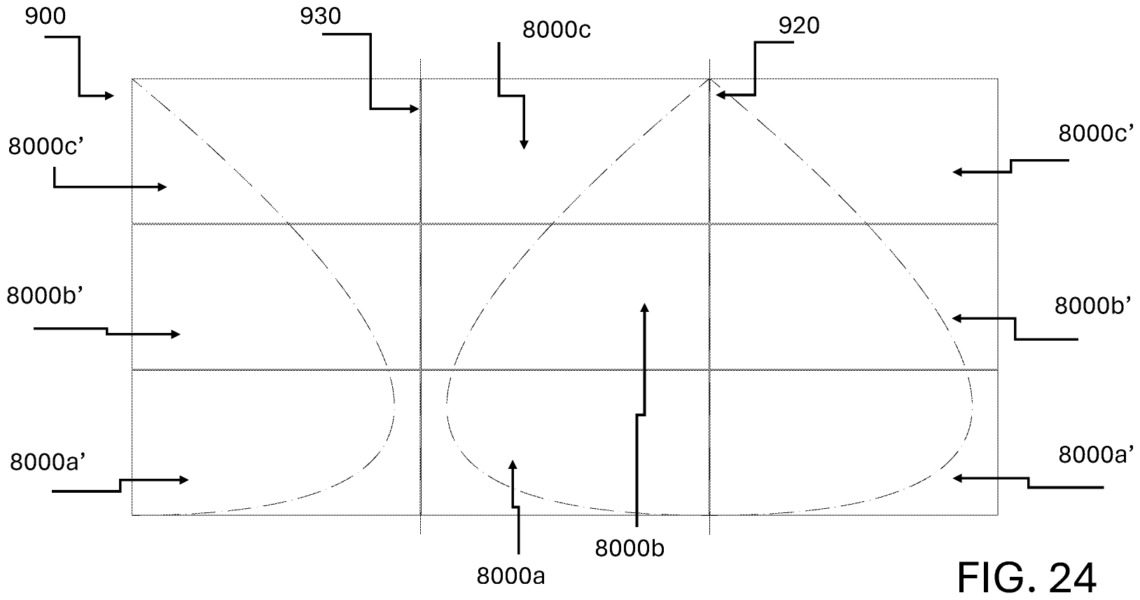

A wall panel assembly system 900 is illustrated in FIGS. 22 and 23. The wall panel assembly system 900 comprises six types of acoustic wall panels 8000, for example. Each of the six types of acoustic wall panels 8000 has a different aesthetic design printed thereon. As such, each of the six types of acoustic wall panels 8000 has been labeled with a different reference character, i.e., 8000a, 8000a′, 8000b, 8000b′, 8000c, and 8000c′. The designs printed on the acoustic wall panels 8000a-8000c and 8000a′-8000c′ are part of a book match set where the acoustic wall panels 8000a-8000c comprise a left page and the acoustic wall panels 8000a′-8000c′ comprise a right page that is a mirror image of the left page centered about a reflection line 920. Moreover, as can be seen in FIGS. 23 and 24, the collective design of a set of acoustic wall panels 8000a, 8000a′, 8000b, 8000b′, 8000c, and 8000c′ is repeated with respect to a reflection line 930.

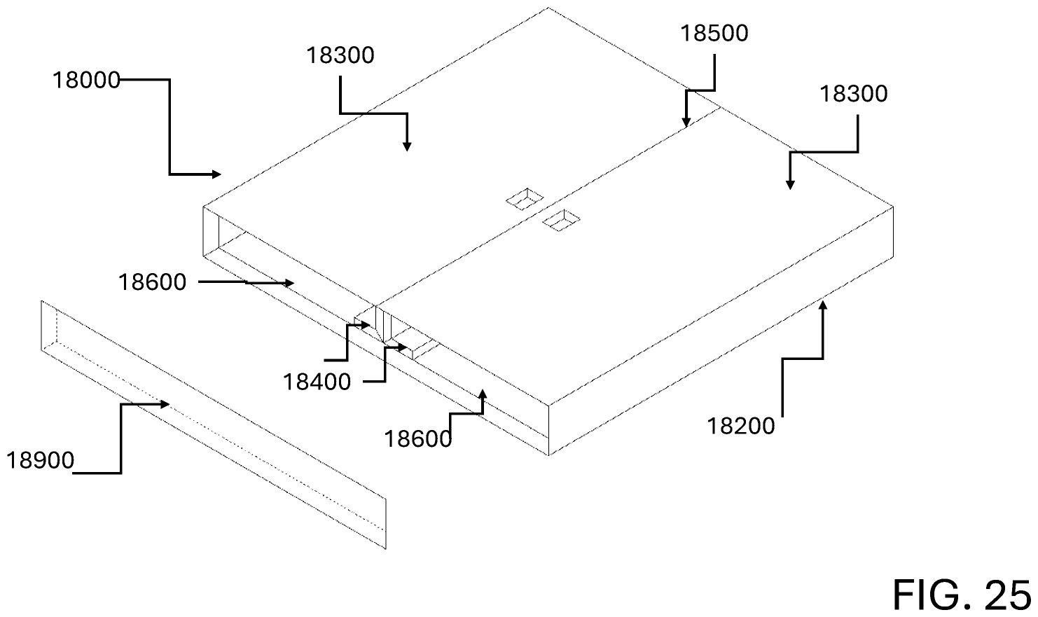

An acoustic wall panel 18000 is illustrated in FIG. 25. The acoustic wall panel 18000 is similar to the acoustic wall panel 7000 in many respects and comprises a front panel, side panels 18200 extending from the front panel, rear panels 18300 extending from the side panels 18200, and connecting panels 18400 extending from the rear panels 18300 that are connected to the front panel 18100. The acoustic wall panel 18000 further comprises end caps 18900 attached thereto that enclose plenums 18600. Notably, the connecting panels 18400 are in close proximity to one another and define a small gap 18500 therebetween, and not an extensive plenum.

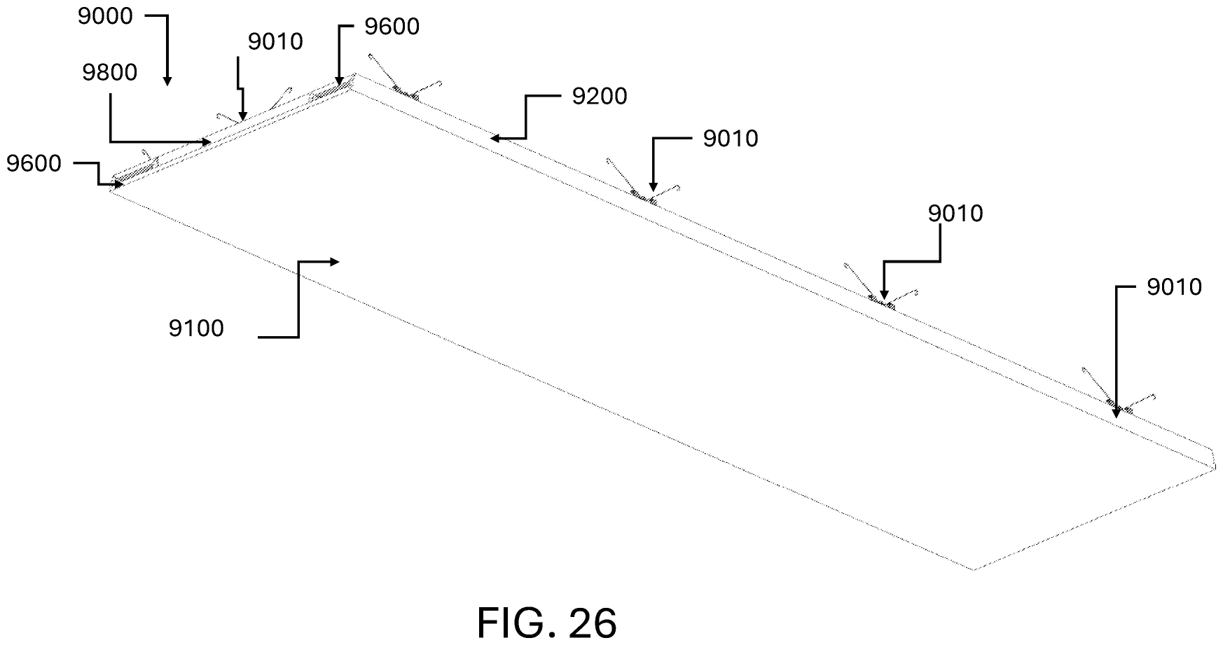

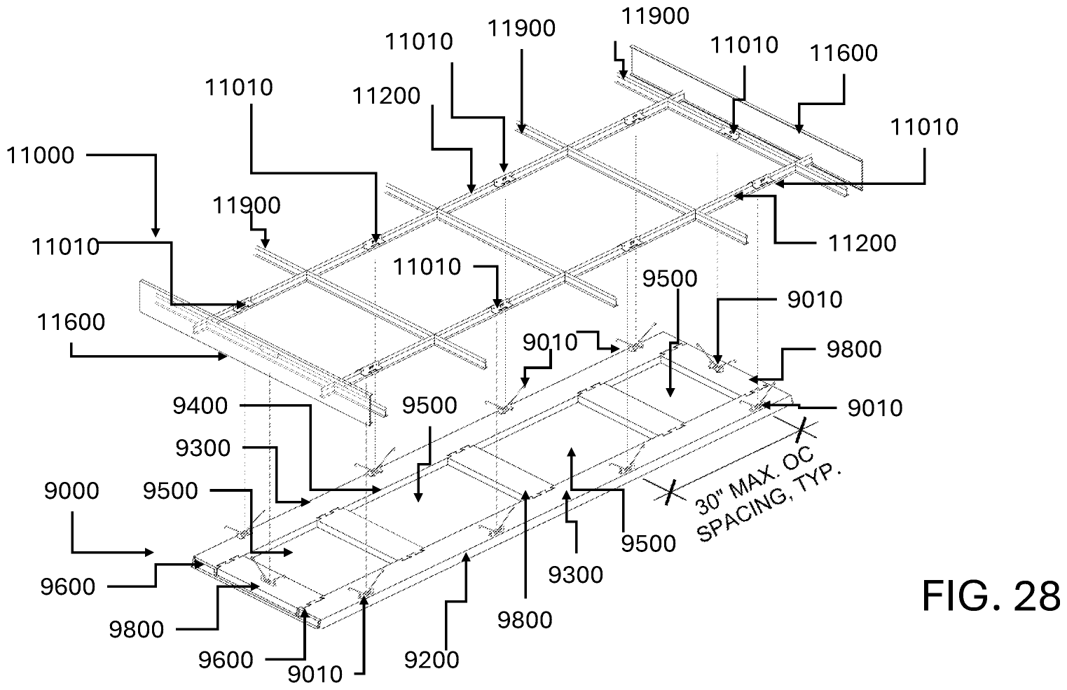

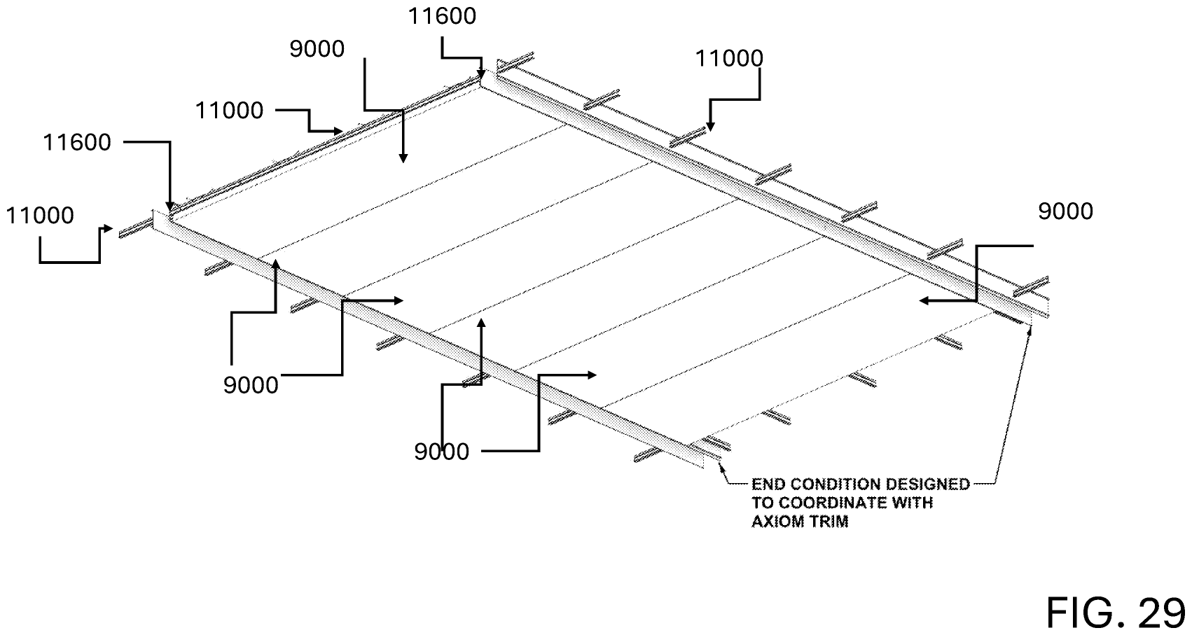

The teachings and advantages provided in connection with the acoustic wall panels 1000 and 7000, among the other wall panels disclosed herein, can be applied to acoustic ceiling panels. Such an acoustic ceiling panel, i.e., acoustic ceiling panel 9000, for example, is illustrated in FIGS. 26-29. The acoustic ceiling panel 9000 comprises a front panel 9100, side panels 9200 extending from opposite sides of the front panel 9100, rear panels 9300 extending from the side panels 9200, and connecting panels 9400 extending from the rear panels 9300 that are connected to the back side of the front panel 9100. The front panel 9100, the side panels 9200, the rear panels 9300, and the connecting panels 9400 define unenclosed interior spaces, or plenums, 9600 therein. Air is present in the plenums 9600 but the plenums 9600 are otherwise empty. Further to the above, the acoustic ceiling panel 9000 further comprises rear covers 9800 mounted to the back side of the front panel 9100. Each rear cover 9800 defines an enclosed interior space, or plenum, between the rear cover 9800, the back side of the front panel 9100, and the connecting panels 9400. Similar to the above, air is present in such plenums but the plenums are otherwise empty. In addition, the acoustic ceiling panel 9000 further comprises unenclosed spaces, or plenums, 9500 defined between the back side of the front panel 9100, the connecting panels 9400, and the rear covers 9800. Sound waves passing through the front panel 9100, the side panels 9200, the rear panels 9300, the connecting panels 9400, and/or the rear covers 9800 into the above-discussed plenums can be at least partially absorbed and dissipated when the sound waves within the plenums contact the walls defining the plenums, which can provide a high Noise Reduction Coefficient (NRC) for the acoustic ceiling panel 9000.

In various embodiments, further to the above, the acoustic ceiling panel 9000 is comprised of a material that has an aesthetic color. In certain embodiments, also further to the above, the acoustic ceiling panel 9000 comprises an aesthetic design printed on the front side, or downwardly facing side, of the front panel 9100. In at least one embodiment, a portion of the front side of the front panel 9100 is not printed thereon which allows the aesthetic color of the material to be part of the overall aesthetic presentation of the front panel 9100 in addition to the aesthetic design printed thereon.

Further to the above, the acoustic ceiling panel 9000 comprises torsion spring connectors 9010 mounted to the rear panels 9300 and two of the rear covers 9800, for example, that releasably hold the acoustic ceiling panel 9000 to a ceiling frame 11000. The ceiling frame 11000 comprises a grid of main beams 11200 and transverse beams 11900 connected to the main beams 11200 that is mounted to a building structure. The ceiling frame 11000 further comprises mounting saddles 11010 mounted to the main beams 11200 and/or the transverse beams 11900 that are each configured to releasably receive a torsion spring connector 9010 when an acoustic ceiling panel 9000 is assembled to the ceiling frame 11000. The torsion spring connectors 9010 are sufficiently spaced apart to closely hold the acoustic ceiling panel 9000 to the ceiling frame 11000 without undesirable gaps being present between the acoustic ceiling panel 9000 and the ceiling frame 11000 and/or between adjacent ceiling panels 9000. In at least one embodiment, the torsion spring connectors 9010 are spaced apart 30″ or less, for example, but can be spaced any suitable distance.

The ceiling frame 11000 further comprises end panels, or end conditions, 11600 that comprise an aesthetic design printed thereon that is configured to match, or complement, an aesthetic design printed on the front side of the front panel 9100. Similarly, the end conditions 11600 comprise an overall aesthetic presentation that matches, or complements, the overall aesthetic presentation of the front side of the front panel 9100. Moreover, the end conditions 11600 comprise an aesthetic printed design and/or an overall aesthetic presentation that matches, or complements, an aesthetic printed design and/or an overall aesthetic presentation of acoustic wall panels, such as acoustic wall panels 1000 and/or 7000, for example, used in connection with the acoustic ceiling panels 9000.

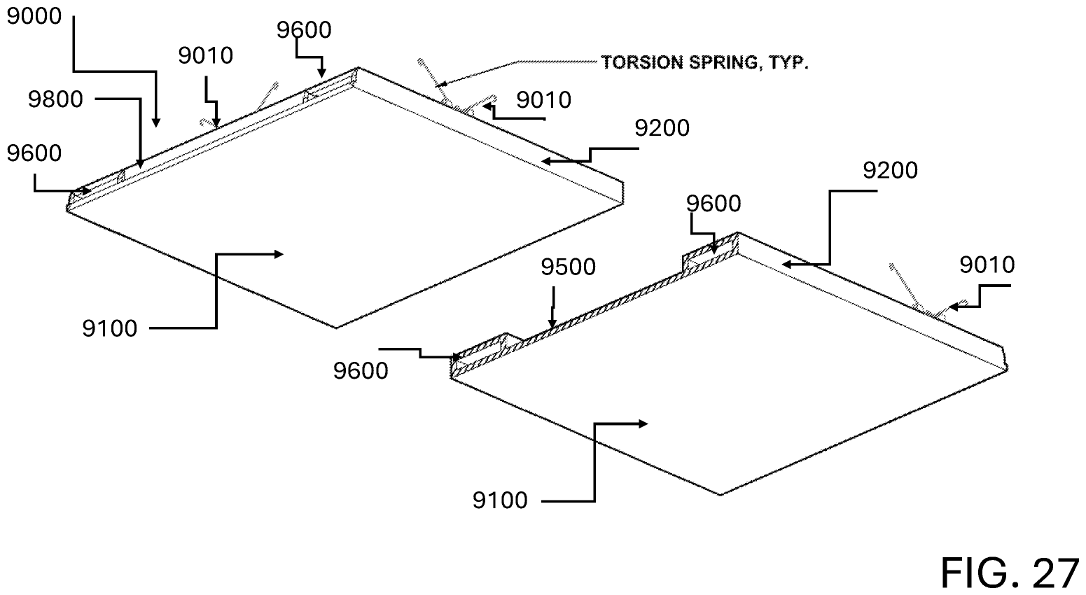

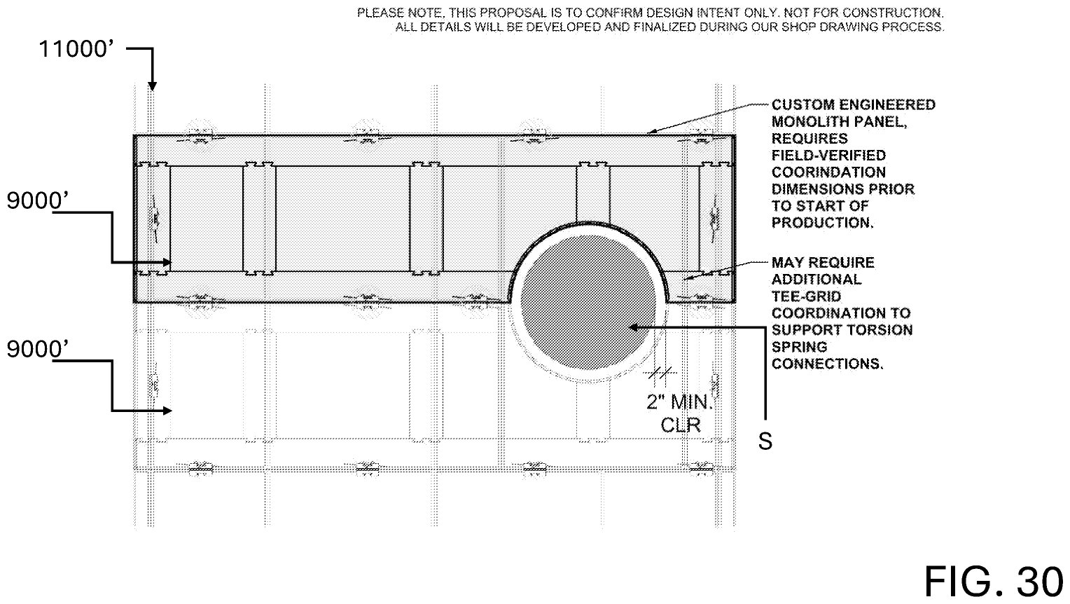

As illustrated in FIGS. 27-29, the acoustic ceiling panel 9000 is rectangular. An alternative embodiment of an acoustic ceiling panel system is illustrated in FIG. 30 that comprises a ceiling frame 11000′ and acoustic ceiling panels 9000′ attached to the ceiling frame 11000′. The ceiling frame 11000′ and the acoustic ceiling panels 9000′ have configurations that accommodate a large structural element S, such as a column or pillar, for example.

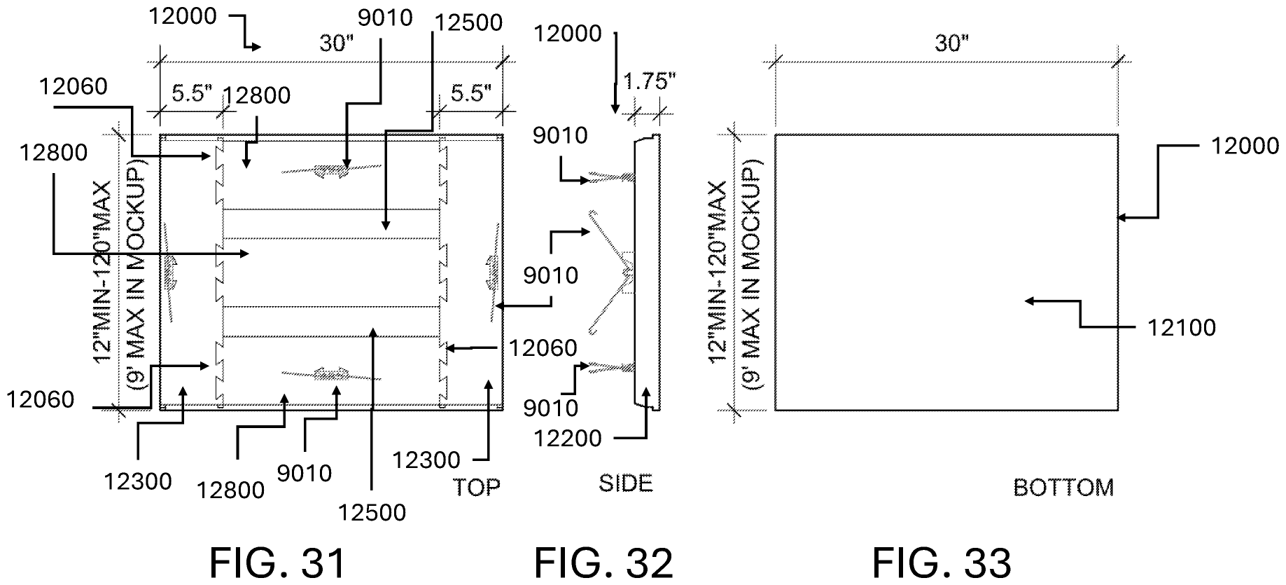

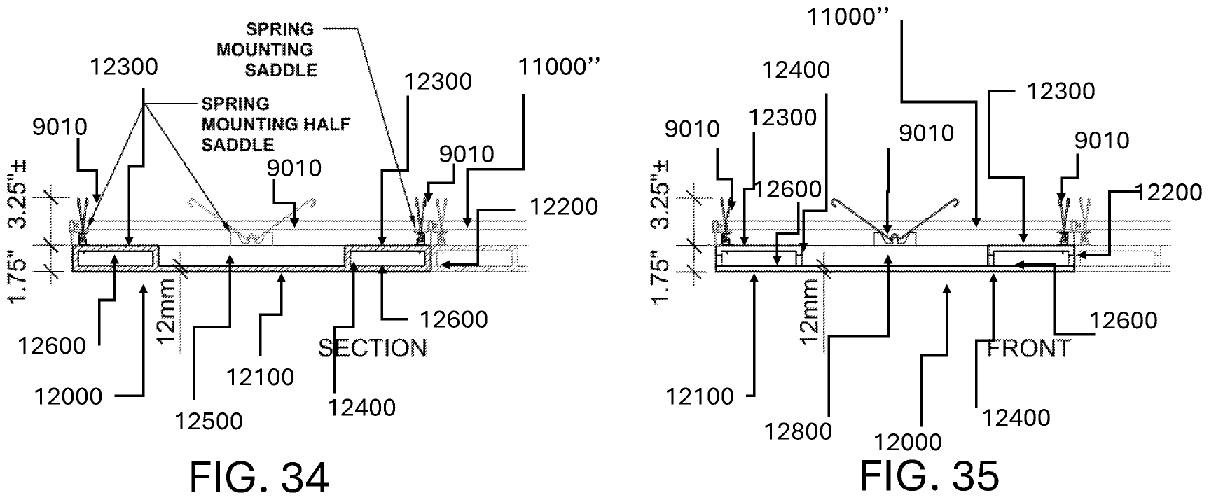

Another acoustic ceiling panel 12000 is illustrated in FIGS. 31-37. Similar to the acoustic ceiling panel 9000, the acoustic ceiling panel 12000 comprises a front panel 12100, side panels 12200 folded rearwardly from the front panel 12100, rear panels 12300 folded inwardly from the side panels 12200, and connecting panels 12400 that are folded toward and connected to the back side of the front panel 12100. The acoustic ceiling panel 12000 has a width of 30″, for example, but can have any suitable width. The acoustic ceiling panel 12000 has a length between 12″ and 120″, for example, but can have any suitable length. The back side of the front panel 12100, the side panels 12200, the rear panels 12300, and the connecting panels 12400 define interior spaces, or plenums, 12600. The ends of the plenums 12600 are unenclosed, but could be enclosed in other embodiments. The acoustic ceiling panel 12000 further comprises rear covers 12800 connected to and extending between the rear panels 12300. The rear covers 12800, the connecting panels 12400, and the rear panels 12300 comprise co-operating dovetail connections 12060 that attach the rear covers 12800 to the rear panels 12300. Similar to the rear covers 9800, the rear covers 12800 define interior spaces, or plenums, that are enclosed by the back side of the front panel 12100, the connecting panels 12400, and the rear covers 12800. Moreover, the acoustic ceiling panel 12000 further comprises unenclosed spaces, or plenums, 12500 defined intermediate the rear covers 12800. Sound waves passing through the front panel 12100, the side panels 12200, the rear panels 12300, the connecting panels 12400, and/or the rear covers 12800 into the above-discussed plenums can be at least partially absorbed and dissipated when the sound waves within the plenums contact the walls defining the plenums, which can provide a high Noise Reduction Coefficient (NRC) for the acoustic ceiling panel 12000.

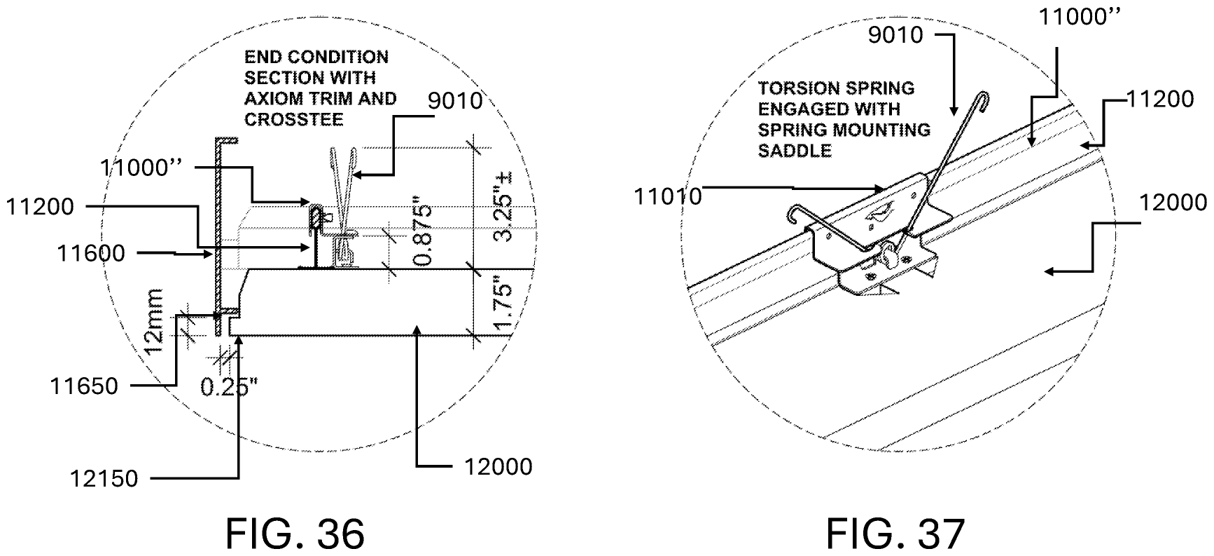

Referring primarily to FIGS. 36 and 37, the ceiling panel 12000 is configured to be attached to a ceiling frame 11000″. The ceiling frame 11000″ is similar to the ceiling frame 11000 and/or 11000′ in many respects. For instance, the ceiling frame 11000″ comprises a grid of beams mounted to a building structure and mounting saddles 11010 mounted to the beam grid. Similar to the acoustic ceiling panel 9000, the acoustic ceiling panel 12000 comprises torsion spring connectors 9010 mounted to the back side thereof that are configured to releasably engage the mounting saddles 11010 and hold the ceiling panel 12000 in position. Referring to FIG. 36, the acoustic ceiling panel 12000 further comprises a lip 12150 extending therefrom and the end condition 11600, discussed above, comprises a shoulder 11650 extending therefrom that co-operates with the lip 12150 to close, or at least reduce the visibility of, a gap between the acoustic ceiling panel 12000 and the end condition 11600.

The entire disclosures of U.S. Patent Application Publication No. 2022/0246126, entitled APPARATUS AND SYSTEM FOR DYNAMIC HIGH NRC ACOUSTIC LOCKING WALL TILE AND METHODS THEREOF, which published on Aug. 4, 2022 and U.S. Pat. No. 9,194,123, entitled CEILING SYSTEM, which issued on Nov. 24, 1995, are incorporated by reference herein.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents. In addition, all combinations of any and all of the features described in the disclosure, in any combination, are part of the invention.

What is claimed is:

1. An acoustic panel, comprising:
a first enclosed chamber;
a second enclosed chamber;
a front panel; and
an unenclosed chamber defined between the first enclosed chamber, the second enclosed chamber, and the front panel.

2. The acoustic panel of claim 1, wherein the first enclosed chamber, the second enclosed chamber, and the front panel are comprised of a single piece of folded material.

3. The acoustic panel of claim 2, wherein the folded material is comprised of polyethylene terephthalate felt.

4. The acoustic panel of claim 2, wherein the single piece of folded material comprises score marks to facilitate the folding of the single piece of folded material.

5. The acoustic panel of claim 2, wherein the single piece of folded material comprises a base color, wherein the front panel comprises a front face, and wherein the front face comprises an ink applied thereto.

6. The acoustic panel of claim 2, wherein the single piece of folded material comprises a base color, wherein the front panel comprises a front face, and wherein the front face comprises:
printed regions where an ink has been applied thereto; and
unprinted regions where an ink has not been applied thereto thereby allowing the base color to be exposed in the unprinted regions.

7. The acoustic panel of claim 2, further comprising locking tabs that hold the acoustic panel in a folded configuration without the use of fasteners.

8. The acoustic panel of claim 1, further comprising end caps assembled thereto that enclose the first and second enclosed chambers.

9. The acoustic panel of claim 1, wherein the front panel comprises a front design thereon, and wherein the acoustic panel further comprises:
a first side panel extending from a first side of the front panel, wherein the first side panel comprises a first design thereon, and wherein the first design is an extension of the front design; and
a second side panel extending from a second side of the front panel, wherein the second side panel comprises a second design thereon, and wherein the second design is an extension of the front design.

10. The acoustic panel of claim 9, wherein the first design extends from the front design without a seam therebetween, and wherein the second design extends from the front design without a seam therebetween.

11. The acoustic panel of claim 9, wherein the front design, the first design, and the second design are at least partially comprised of printed ink.

12. The acoustic panel of claim 1, wherein the front panel comprises a front face comprised of felt having a design thereon, wherein the felt comprises a base color, wherein the design comprises a first zone and a second zone, wherein the first zone comprises the base color of the felt, wherein the second zone comprises a second color on the felt, and wherein the second color is different than the base color.

13. The acoustic panel of claim 12, wherein the second color comprises ink printed on the felt.

14. The acoustic panel of claim 13, further comprising a colorantless coating applied to the first zone and the second zone.

15. The acoustic panel of claim 13, further comprising a transparent coating applied to the first zone and the second zone.

16. The acoustic panel of claim 13, further comprising an inkless coating applied to the first zone and the second zone.

17. The acoustic panel of claim 13, wherein the design further comprises a third zone intermediate the first zone and the second zone, wherein the third zone comprises interspersed regions of the base color of the felt and the second color of the ink.

18. The acoustic panel of claim 12, wherein the design further comprises a third zone intermediate the first zone and the second zone, wherein the third zone comprises a third color on the felt, and wherein the third color is different than the base color and the second color.

19. A panel assembly system, comprising:
a first acoustic panel comprising a first front panel and a first front design printed on the first front panel; and
a second acoustic panel comprising a second front panel and a second front design printed on the second front panel, wherein the second front design is an extension of the first front design.

20. The panel assembly system of claim 19, wherein the first acoustic panel and the second acoustic panel are comprised of felt, wherein the felt comprises a base color, wherein the first front design and the second front design collectively comprise a first zone and a second zone, wherein the first zone comprises the base color of the felt, wherein the second zone comprises a second color on the felt, and wherein the second color is different than the base color.
